(19) United States
(12) Patent Application Publication
(10) Pub. No.: US 2004/0049369 A1
(43) Pub. Date: Mar. 11, 2004

(54) System and method for facilities management

(76) Inventors: Joseph G. Konicek, Maple Plain, MN (US); Kym Clark, Minnetonka, MN (US); John Jones, Minnetonka, MN (US); Wendee Larson, Minnetonka, MN (US); Jeff Threlkeld, Savage, MN (US); Rowdy Foster, Chaska, MN (US); Terry Olson, Long Lake, MN (US); Bill Mead, Eden Prairie, MN (US); Dave Kloyda, Plymouth, MN (US)

Correspondence Address: FOLEY & LARDNER, 777 EAST WISCONSIN AVENUE, SUITE 3800, MILWAUKEE, WI, 53202-5308, US

(21) Appl. No.: 10/232,959

(22) Filed: Aug. 31, 2002

(51) Int. Cl. G06G 7/48

(52) U.S. Cl. 703/7

(57) ABSTRACT

Systems and methods for managing a facility such as a production facility, mill, plant, etc. are disclosed. One such system includes a system for modeling a production plant. The system includes a processing unit and a memory portion in communication with the processing unit having information stored to configure the processing unit to receive model data for the production plant, receive operational data for the production plant, compare the operational plant data to the model plant data, and generate a report at least daily containing the comparison between the operational plant data and the model plant data. One such method includes a method of managing a facility having at least one process, the at least one process having a plurality of steps. The method includes receiving model data relating to the plurality of steps of the at least one process, receiving actual data relating to the plurality of steps of the at least one process, and comparing the model data to the actual data.

### BACKGROUND OF THE INVENTION

The present invention relates generally to systems and methods for facilities management. More specifically, the present invention relates to systems and methods for managing and analyzing production and operations data for facilities such as mills, plants, production facilities, factories, manufacturing facilities, production plants, etc.

The production and management of facilities, such as mills, is becoming increasingly more complicated. The number of systems and processes involved with producing product (such as a feed product) can pose challenges for management including optimizing operational efficiency, production efficiency, costs, budgeting, etc.

Accordingly, it would be advantageous to provide a system and method that may be used to determine a number of personnel at a plant to meet a sales or production level. It would also be advantageous to provide a system and method that may be used to manage production costs of product (such as animal feed, etc.). It would further be advantageous to provide a system and method that may be used to identify inefficiencies and “bottlenecks” in a production process. It would further be advantageous to provide a system and method that may be used to provide modeling of process changes (such as “what-if-modeling”) and to determine the cost effect of any changes. It would further be advantageous to provide a system and method that may be used to assist in the preparation of a budget for a mill. It would further be advantageous to provide a system and method that may be used to allocate costs by process, variable costs, and fixed costs, and to determine incremental costs of production (such as marginal costs).

It would be advantageous to provide a system and method for facilities management of a type disclosed in the present application that includes any one or more of these or other advantageous features.

### SUMMARY OF THE INVENTION

One embodiment of the invention relates to a system for modeling a production plant. The system includes a processing unit and a memory portion in communication with the processing unit having information stored to configure the processing unit to receive model data for the production plant, receive operational data for the production plant, compare the operational plant data to the model plant data, and generate a report at least daily containing the comparison between the operational plant data and the model plant data.

Another embodiment of the invention relates to a method of managing a transfer of material within a plant. The method includes receiving model bin storage data, receiving model flat storage data, generating model data from the model bin storage data and the model flat storage data, receiving actual transfer data, and comparing the model data with the actual transfer data.

Another embodiment of the invention relates to a method of managing physical maintenance of a plant. The method includes receiving model maintenance data, generating model data from the model maintenance data, receiving actual maintenance data, and comparing the model data with the actual maintenance data. The model maintenance data includes data relating to at least one of a Mezzannine area, and a sweeping time based on empirical data.

Another embodiment of the invention relates to a method of managing personnel time for a recurring meeting in a plant. The method includes receiving model data relating to a number of employees for the recurring meeting, receiving model data relating to a time per employee for the recurring meeting, generating model data relating to a total number of hours required for the recurring meeting, receiving actual data relating to a total number of hours for the recurring meeting, and comparing the model data relating to the total number of hours required for the recurring meeting with the actual data relating to the total number of hours for the recurring meeting.

Another embodiment of the invention relates to a method of managing a bag material receiving process in a plant. The method includes receiving model bag receiving data, generating model data from the model bag receiving data, receiving actual bag receiving data, and comparing the model data with the actual bag receiving data. The model bag receiving data further includes data relating to at least one of amount of bag material received with a forklift, and a capacity of the forklift.

Another embodiment of the invention relates to a method of managing a bulk material receiving process in a plant. The method includes receiving model dumping data, generating model data from the model dumping data, receiving actual dumping data, and comparing the model data with the actual dumping data.

Another embodiment of the invention relates to a method of managing a mixing process in a plant. The method includes receiving model mixing data, generating model data from the model mixing data, receiving actual mixing data, and comparing the model data with the actual mixing data. The model mixing data further comprises data relating to at least one of a best practice time for mixing, and a batches per hour.

Another embodiment of the invention relates to a method of managing a packing process in a plant. The method includes receiving model dry packing data, receiving actual dry packing data, and comparing the model dry packing data with the actual dry packing data. The method further includes receiving model wet packing data, receiving actual wet packing data, and comparing the model wet packing data with the actual wet packing data.

Another embodiment of the invention relates to a method of managing a shipping process in a plant. The method includes receiving model shipping data, generating model data from the model shipping data, receiving actual shipping data, and comparing the model data with the actual shipping data. The model shipping data includes data relating to one of a set time for a rail car, a clean time for a rail car, a sample time for a rail car, a weigh time for a rail car, an operator rate for a rail car, a load rate for a rail car, a wet clean rate, a wet load rate, a wet average tons per item, and a resacking rate.

Another embodiment of the invention relates to a method of managing a pelleting process in a plant. The method includes receiving model pelleting data, generating model data from the model pelleting data, receiving actual pelleting data, and comparing the model data with the actual pelleting data. The model pelleting data includes data relating to one of die friction, throughput of a pelleting machine, energy cost of the pelleting machine, and a time required to change a die of a pelleting machine.

Another embodiment of the invention relates to a method of managing a maintenance process in a plant. The method includes receiving model maintenance data, generating model data from the model maintenance data, receiving actual maintenance data, and comparing the model data with the actual maintenance data. The model maintenance data further comprises data relating to one of a number of extruders, and a number of dryers.

Another embodiment of the invention relates to a method of managing an energy consumption process in a plant. The method includes receiving model energy consumption data, generating model data from the model energy consumption data, receiving actual energy consumption data, and comparing the model data with the actual energy consumption data. The model energy consumption data include data relating to one of an energy amount associated with an extruding process, an energy amount associated with an extrusion screen, an additional amount of steam, an additional BTU usage, and wet packing amps.

Another embodiment of the invention relates to method of managing operations processes in a plant. The method includes receiving model operations processes data, generating model data from the model operations processes data, receiving actual operations processes data, and comparing the model data with the actual operations processes data. The model operations processes data further comprises data relating to one of a cost associated with a security guard and a currency conversion.

Another embodiment of the invention relates to a method of managing contract labor in a plant. The method includes receiving model contract labor data, receiving actual contract labor data, and comparing the model contract labor data with the actual contract labor data. The model contract labor data and the actual contract labor data include data relating to a cost associated with contracting one of interplant transfer, bag receiving, bulk receiving, mixing, packing, wet packing, bulk warehouse, bag warehouse, pelleting, grinding, second mixing, rolling, flaking, grain processing, block pressing, and extruding.

Another embodiment of the invention relates to a method of managing an extruding process in a plant. The method includes receiving model extruding data, generating model data from the model extruding data, receiving actual extruding data, and comparing the model data with the actual extruding data. The model extruding data includes data relating to a cost associated with one of an energy cost associated with the extruding process and a labor cost associated with the extruding process.

Another embodiment of the invention relates to a method of managing a facility having at least one process, the at least one process having a plurality of steps. The method includes receiving model data relating to the plurality of steps of the at least one process, receiving actual data relating to the plurality of steps of the at least one process, and comparing the model data to the actual data.

Another embodiment of the invention relates to a method of providing consulting services. The method includes receiving, by a consulting servicer, operational data from a production plant, generating model data for the production plant, generating comparison data from the operational data and the model data, by the consulting servicer. The method further includes generating, by the consulting servicer, a report analyzing the operational data, the model data and the comparison data.

Another embodiment of the invention relates to a method of providing management reports for a production plant. The method includes receiving operational data at least partially automatically from machines in the production plant, by a data processing device, generating model data for the production plant using a production plant modeling program running on the data processing device, and generating a report based on the operational data and the model data.

### BRIEF DESCRIPTION OF THE DRAWINGS

FIG. 1 is a schematic view of a facilities management system according to an exemplary embodiment.

FIG. 2 is a schematic view of a facilities management system according to an exemplary embodiment.

FIG. 3 is a schematic view of a process for managing a facility according to an exemplary embodiment.

FIG. 4 is a schematic view of a facilities management system according to an exemplary embodiment applied to various process.

FIG. 5 is a portion of a user interface for a facilities management system according to an exemplary embodiment.

FIG. 6 is a portion of a user interface for a model process according to an exemplary embodiment.

FIG. 7 is a portion of a user interface for a model process according to an exemplary embodiment.

FIG. 8 is a portion of a user interface for a model process according to an exemplary embodiment.

FIG. 9 is a portion of a user interface for a model process according to an exemplary embodiment.

FIG. 10 is a portion of a user interface for a model process according to an exemplary embodiment.

FIG. 11 is a portion of a user interface for a model process according to an exemplary embodiment.

FIG. 12 is a portion of a user interface for a model process according to an exemplary embodiment.

FIG. 13 is a portion of a user interface for a model process according to an exemplary embodiment.

FIG. 14 is a portion of a user interface for a model process according to an exemplary embodiment.

FIG. 15 is a portion of a user interface for a model process according to an exemplary embodiment.

FIG. 16 is a portion of a user interface for a model process according to an exemplary embodiment.

FIG. 17 is a portion of a user interface for a model process according to an exemplary embodiment.

FIG. 18 is a portion of a user interface for a model process according to an exemplary embodiment.

FIG. 19 is a portion of a user interface for a model process according to an exemplary embodiment.

FIG. 20 is a portion of a user interface for a model process according to an exemplary embodiment.

FIG. 21 is a portion of a user interface for a model process according to an exemplary embodiment.

FIG. 22 is a portion of a user interface for a model process according to an exemplary embodiment.

FIG. 23 is a portion of a user interface for entry of actual data according to an exemplary embodiment.

FIG. 24 is a portion of a user interface for entry of actual data according to an exemplary embodiment.

FIG. 25 is a portion of a user interface for entry of actual data according to an exemplary embodiment.

FIG. 26 is a portion of a user interface for generating of summary data according to an exemplary embodiment.

FIG. 27 is a schematic view of a facilities management system according to an alternative embodiment.

FIG. 28 is a portion of a user interface for a model process according to an alternative embodiment.

FIG. 29 is a portion of a user interface for a model process according to an alternative embodiment.

FIG. 30 is a portion of a user interface for a model process according to an alternative embodiment.

FIG. 31 is a portion of a user interface for a model process according to an alternative embodiment.

FIG. 32 is a portion of a user interface for a model process according to an alternative sembodiment.

### DETAILED DESCRIPTION OF THE PREFERRED EMBODIMENTS

Systems and methods for facilities management are disclosed. The systems and methods disclosed assist management of one or more mills (e.g. facilities, plants, production facilities, factories, production plants, manufacturing facilities, etc.). The systems and methods disclosed provide and allow comparison of criteria by which one or more mills may be managed, modeled, budgeted, compared and/or otherwise analyzed. The systems and methods disclosed provide comparison of production data of an actual facility with a “model” facility (e.g., data representative of a facility, similar to the actual facility, operating according to predetermined, idealized, optimized, or preset production/operation data).

1. Facilities Management System

In one embodiment, a computer system is used which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any specific combination of hardware circuitry and software, nor to any particular source for the instructions executed by the computer system.

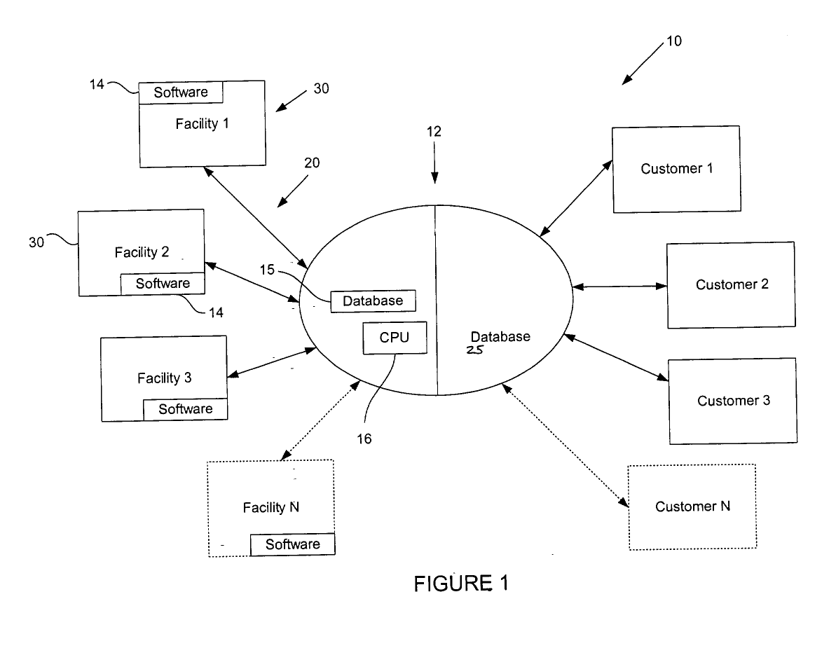

FIG. 1 shows a facilities management system 10. Facilities management system 10 may, in an exemplary embodiment, comprise a server 12, a network 20 and one or more remote computer systems 30. Network 20 connects server 12 and one or more computer systems 30. In an exemplary embodiment, network 20 is the Internet, a worldwide network of computer networks that use various protocols to facilitate data transmission and exchange. Network 20 can use a protocol, such as, but not limited to, the TCP/IP network protocol or the DECnet, X.25, and UDP protocols. In alternative embodiments, network 20 is any type of network, such as, but not limited to, a virtual private network (VPN), an Ethernet, or a Netware network. Further, network 20 may comprise a configuration, such as but not limited to, a wide area network (WAN) or a local area network (LAN). Network 20 preferably provides communication via a CITRIX server or other server platform. Alternatively, Hypertext Markup Language (HTML), extensible markup language (XML) web pages, or other communications protocols and communications interfaces may be used.

Generally, system 10 can be implemented using computer server 12 configured by software 14 running on server 12. According to various alternative embodiments, software may be run on a number of different locations, including on the remote computer system, one or more servers in communication with each other, etc.

Server 12 may have a central processing unit (CPU 16) that executes sequences of instructions (e.g., software) contained in a memory to perform steps which are described below. Preferably, server 12 includes read/write memory, such as, disc drives and other storage.

A user (e.g., manager, system administrator, personnel, etc.) may access system 10 via a CITRIX platform, web pages having secure, time restricted access, etc.

As shown in FIG. 1, a database 15 may be provided on server 12. Database 15 may be used to store data relating to one or more models, actual data, reports, etc. According to one exemplary embodiment, two separate databases may be provided on server 12. One data base (i.e., database 15) may serve internal plants or facilities, the other data base (i.e., database 25) may serve outside customers for consulting purposes, etc.

Computer system 30 may be any type of computing device, including work stations, laptop computers, notebooks, computers, handheld computers, personal digital assistants (PDAs), mobile phones, beepers, or other equipment capable of communication with network 20. In another embodiment, system 10 can be accessed via telephones, such as, a mobile phone or a standard telephone. Other user interface platforms may also be provided for accessing system 10. Such user interface platforms include, but are not limited to, for example, WAP (wireless application protocol) and web browser interfaces.

According to an alternative embodiment, software and databases may be provided on remote computer systems at the facility. The remote computer systems may be configured to autonomously run the software, store inputted data, generate reports and/or analysis, and store generated data. The remote computer systems may be configured to be in selective communication with a central server (i.e., data may be selectively uploaded to the server).

2. Facilities

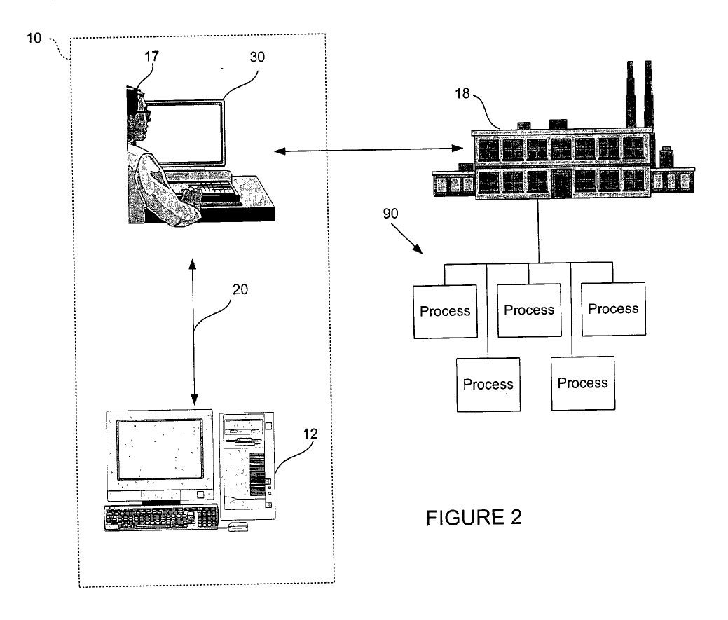

As shown in FIG. 2, system 10 may be used by a user 17 (e.g., a plant manager, process engineer, supervisor, employee, contractor, consultant, etc.) to provide analysis (e.g., management, modeling, budgeting, comparison, etc.) of a facility 18 (shown as a mill).

System 10 may be configured to analyze one or more facilities. According to a particularly preferred embodiment shown in FIG. 1, system 10 may be used on any number of facilities. The facilities may be organized or grouped for analysis according to various criteria such as geographic location, facility type, capacity, size, division, individually, etc.

3. Models and Model Data

According to an exemplary embodiment, user 17 may include a plant manager and a production manager in charge of a region, district, selected plants, etc. who may be jointly responsible for analysis of the facility.

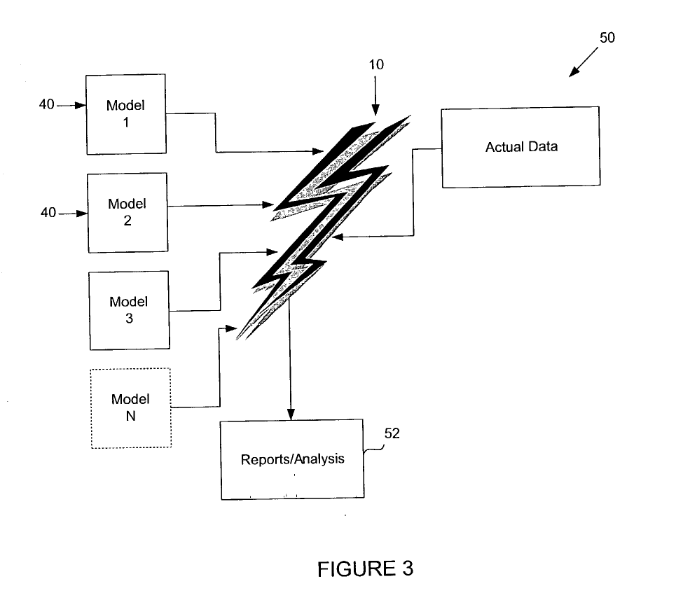

As shown in FIG. 3, model(s) 40 of facility 18 will typically include model data relating to processes (e.g. work-flows, production steps, management steps, work processes) occurring in or associated with the facility. Model(s) 40 may be based on theoretical data, production capacities, time studies, operational capacities, estimates, ideal costs, etc.

As shown in FIG. 3, one or more models for a facility may be created. Models 40 may be created to allow analysis of the facility, to compare a variety of different models having different data, etc. Multiple models also allows a user to review a number of scenarios for changing the operation of the facility (e.g., to see effects from changing one or more operational parameters).

4. Facilites and Actual Data

As the facility operates, actual data 50 (e.g., operational data, production data, actual costs, actual labor times, etc.) is entered or received into system 10 (see FIG. 3). According to a particularly preferred embodiment, actual data may be obtained from employee time sheets, timing the processes, actual costs, completing forms, data entry, data entry terminals provided at or near the processes, etc. According to alternative embodiments, data may be received from a direct link to the process (e.g., time to pack product received from automated packing equipment, monitoring systems to track employee locations, etc.).

5. Example Analysis

System 10 may make comparisons between the model data and the actual data, project costs, identify discrepancies, bottlenecks, etc. (see operation 52 in FIG. 3). Analysis of a facility may include analysis and/or comparison of model data with actual data. Analysis of a facility may include analysis and/or comparison of one or more model data sets.

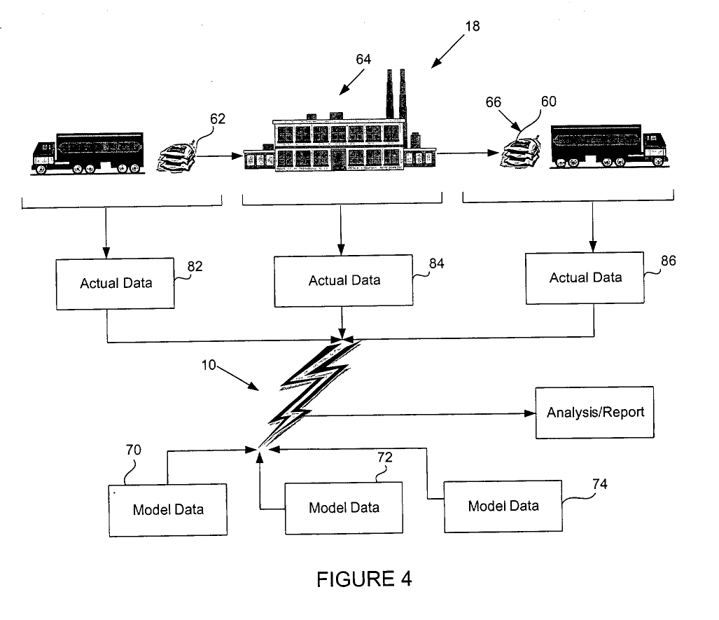

By way of a simplified example shown in FIG. 4, facility 18 may be a feed mill. Facility 18 may produce products 60 (such as animal feed). In order to produce products 60, facility 18 may utilize various processes. For example, a receiving process 62, a mixing process 64, and a shipping process 66 may be used. Receiving process 62 may be a process in which materials for production of products 60 are received within facility 18. Mixing process 64 may be a process in which materials are mixed together to form products 60. Shipping process 66 may be a process in which products 60 are shipped or sent to customers, distributors, etc.

In this simplified example, model data may be generated and/or used for the three processes. The model data may be derived from time studies, theoretical operational capacities, estimates, ideal costs, etc.

For example, model data for the receiving process (e.g., model receiving data 70) may include a model time needed to weigh materials, a model time to sample materials, a model time to unload the materials from the transport, and a model time to place the materials into storage. Model data may be calculated from one or more of these processes or steps.

Model data for the mixing process (e.g., model mixing data 72) may include a model capacity of a mixing machine (e.g., tons/hour, line speed), a model time to mix the materials and a model time to empty the mixing machine. Model data may be calculated from one or more of these processes or steps.

Model data for the shipping process (e.g., model shipping data 74) may include a model time to fill a bag of product, a model distance from a bagging area to a shipment area, a model cost of running loading equipment, and a model rate of shipment capacity (e.g., tons per hour, etc.). Model data may be calculated from one or more of these processes or steps.

In this simplified example, actual data may also be generated for all three processes (e.g., actual receiving data 82, actual mixing data 84, and actual shipping data 86). The actual data will reflect actual operating values for the various processes. The actual data may be obtained from employee time sheets, timing the processes, actual costs, etc.

In this simplified example, model data may then be compared to actual (collected, sensed, and/or recorded) data for analysis. Analysis may be done on factors or data which may have an effect on the operation of the facility (e.g., cost, production, efficiency, volume, etc.).

According to various exemplary embodiments, a wide variety or types of analysis may be done on the model data and/or actual data. For example, model receiving data 70 may be compared to actual receiving data 82. If actual receiving data 82 is greater than model receiving data 70 (e.g., actual time for the receiving process is longer than the model time for receiving), a manager may further review the process in order to find out the cause of the delay.

The receiving data (both model and actual) may include a break-down of all steps or sub-processes that comprise receiving process 62. This information may provide a manager with a way to localize a problem point in the process by comparing a model step (or process) with an actual step (or process). Alternatively, if actual receiving data 82 is less than model receiving data 70, a manager may use this information to award employees for productivity, etc.

Model data, actual data, comparative information, calculated efficiencies, etc. may be provided using system 10. Data may be provided at a number of levels, including at a process level (e.g., time for receiving process), at a step level (e.g., time for unloading a truck) at a facility level (e.g., time from receiving to shipment) or analysis of a group or all facilities (e.g., average time for receiving process). Any and all data may be provided in a variety of formats, including reports, charts, graphs, tables, etc.

6. Facility Processes—Model Data

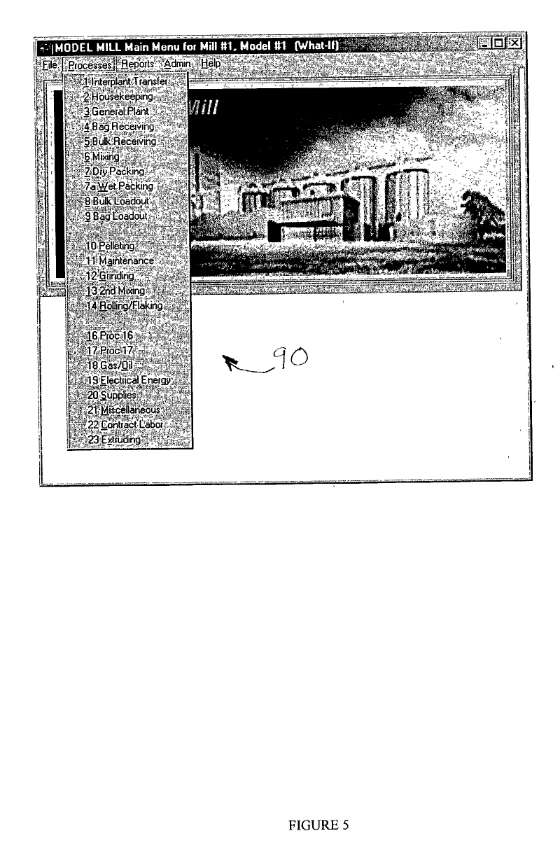

The analysis of a facility largely depends on the various processes being used or employed in the facility. System 10 may model or receive model data relating to one or more processes 90 occurring in the facility (see FIG. 5). The one or more processes 90 may comprise one or more steps (e.g., sub-processes, components, etc.).

According to a particularly preferred embodiment shown in FIG. 5, processes 90 include processes relating to interplant transfer, housekeeping, general plant processes, bag receiving, bulk receiving, mixing, dry packing, wet packing, bulk loadout, bag loadout, pelleting, maintenance, grinding, second mixing, rolling/flaking, user defined processes (shown as Proc 16 and Proc 17), gas/oil, electrical energy, supplies, miscellaneous, contract labor, and extruding. According to an alternative embodiment, the processes used for analysis may include processes used in food business, milling, grain mills, food production, etc., including processing, screening, sifting, sorting, etc.

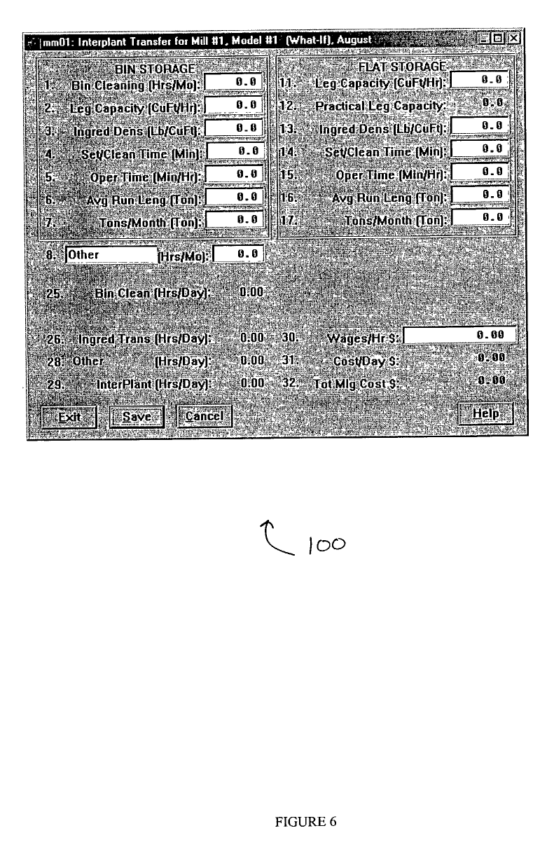

According to one exemplary embodiment shown in FIGS. 6 to 22, model data (for use with a process) may be inputted into fields having a “window” or field allowing changes. Other non-windowed fields may be calculated model values. According to a particularly preferred embodiment, calculated model values are comparable data types to actual data. Calculated model values may be based on one or more inputted data fields in the one or more processes.

a. Interplant Transfer Process

As shown in FIG. 6, interplant transfer process data 100 may include steps and model data associated with transferring or moving product within a facility, such as model data relating to bin and flat storage processes (e.g., time for bin cleaning, rate for bin cleaning, leg capacity, ingredient density, operator time for equipment, set time, clean time, average run length, tons per month, other user defined parameters, etc.). Data 100 may include bin cleaning, ingredient transfer from temporary storage (i.e. totes to bulk or outside bulk storage to mill), and set/clean time. Set/clean time will include any set up time involved in transfers and cleaning areas that are directly effected by the transfer.

| Data | Description |
|---|---|
| Bin Cleaning (Hrs/Mo) | Time for cleaning various bins. |
| Bin Leg Capacity | The leg capacity for bin transfer system. |
| Bin Ingred Dens | The average density of the material being |
| | transferred in the units indicated by the field |
| | label. |
| Bin Set/Clean Time (Min) | May includes time to: |
| | 1) Set distribution |
| | 2) Start equipment |
| | 3) Check flow |
| | 4) Travel time |
| | 5) Shutdown equipment |
| | 6) Clean up |
| Bin Oper Time (Min/Hr) | May be based on a time study. May include |
| | time to: |
| | 1) Monitor equipment |
| | 2) Check heights of material in bin being |
| | filled |
| | 3) Travel time |
| | 4) Operator equipment |
| Bin Avg Run Leng (Ton) | The average run length for bin transfer |
| | system. |
| Bin Tons/Month (Ton) | The amount of bulk ingredients that are |
| | transferred during an average month. |
| Other(Hrs/Mo) | May include the hours per month used to |
| | transfer other products, i.e: ingredients |
| | stored at another warehouse/facility and |
| | moved to facility. |
| Flat Leg Capacity | The leg capacity for flat transfer system. |
| Flat Practical Leg Capacity | The value may be a predetermined operating |
| | factor multiplied by the flat leg capacity. |
| Flat Ingred Dens | The average density of the material being |
| | transferred. |
| Flat Set/Clean Time (Min) | May be based on a time study. May |
| | includes time to: |
| | 1) Set distribution |
| | 2) Start equipment |
| | 3) Check flow |
| | 4) Travel time |
| | 5) Shutdown equipment |
| | 6) Clean up |
| Flat Oper Time (Min/Hr) | May be based on a time study. May include |
| | time to: |
| | 1) Monitor equipment |
| | 2) Check heights of material in bin being |
| | filled |
| | 3) Travel time |
| | 4) Operator equipment |
| Flat Avg Run Leng (Ton) | The average run length for flat transfer |
| | system. |
| Flat Tons/Month (Ton) | The amount of bulk ingredients that are |
| | transferred during an average month. |
| Bin Clean (Hrs/Day) | This field is computed from user inputs. |
| | (Bins required cleaning or the average bins |
| | cleaned × hours per bin × number of times |
| | cleaned per year)/12 = hours per month. |
| Ingred Trans (Hrs/Day) | This field is computed from user inputs |
| | including leg capacity, ingredient density and |
| | tons/month. |
| Other (Hrs/Day) | This field is computed from user inputs |
| | including hours per day to transfer other |
| | products. |
| InterPlant (Hrs/Day) | This field is computed from user inputs |
| | including bin clean, ingredient transfer and |
| | other. |
| Wages/Hr $ | Wages per hour of employees involved with |
| | the process. |
| Cost/Day $ | Cost per ton that the process adds to the |
| | product. |
| Tot MIg Cost $ | Overall cost of milling |

Bin storage data and flat storage data are preferably separate. The cost and/or time associated with transferring or moving product within a facility may vary depending on whether the product is stored in a bin or stored in “flat storage.” Bin storage generally refers to product that is stored in bins, containers, etc. Flat storage generally refers to product that is stored in flat storage areas or sections such as pallets, shelving, stacked, etc. Other transfer process data may be included depending on the facility and types of materials being handled, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

b. Housekeeping Process

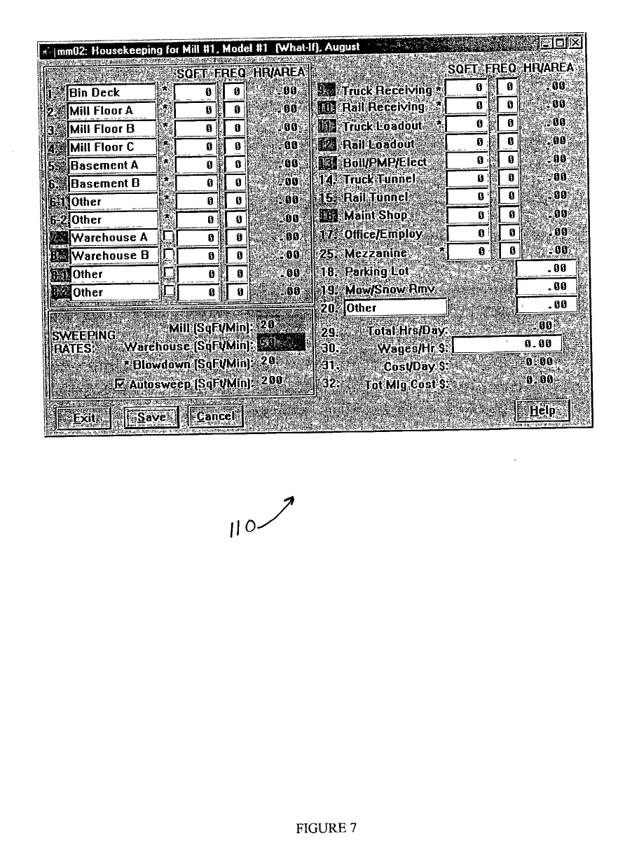

As shown in FIG. 7, housekeeping process data 110 may include steps and model data associated with cleaning and/or upkeep of a facility. The plant may be divided into various sections. The employee may record their time spent cleaning in each area. Examples of sections include: storage roof, shop, compressor room, boiler room, panel room, finished feed bag warehouse, warehouse dock, ingredient bag warehouse, drug room, packer area, table area, main floor, hand add area, pellet mill area, outside bins, basement, floor 1A, floor old 2, floor old 3, floor new 2, floor new 3, floor new 4, floor new 5, bin tops, plant roofs, bulk receiving area, bulk loadout area, plant yard, as well as other areas which may be a part of the facility.

| Data | Description |
|---|---|
| Bin Deck Area | The area of the bin deck. |
| Bin Deck Hskpng Freq | The frequency of housekeeping per month |
| | for the bin deck. |
| Mill Floor A Area | The area of the mill floor A. |
| Mill Floor A Hskpng Freq | The frequency of housekeeping per month |
| | for mill floor A. |
| Mill Floor B Area | The area of mill floor B. |
| Mill Floor B Hskpng Freq | The frequency of housekeeping per month |
| | for mill floor B. |
| Mill Floor C Area | The area of Mill Floor C. |
| Mill Floor C Hskpng Freq | The frequency of housekeeping per month |
| | for mill floor C. |
| Basement A Area | The area of Mill Basement A, |
| Basement A Hskpg Freq | The frequency of housekeeping per month |
| | for basement A. |
| Basement B Area | The area of Mill Basement B. |
| Basement B Hskpng Freq | The frequency of housekeeping per month |
| | for the basement B. |
| Warehouse A Area | The area of Warehouse A. |
| Warehouse A Hskpng Freq | The frequency of housekeeping per month |
| | for warehouse A. |
| Autosweep | Autosweep rate. |
| Warehouse B Area | The area of Warehouse B. |
| Warehouse B Hskpng Freq | The frequency of housekeeping per month |
| | for warehouse B. |
| Truck Receiving Area | The area of the truck receiving area. |
| Truck Receiving Hskpng Freq | The frequency of housekeeping per month |
| | for truck receiving. |
| Truck Receiving | This field is computed from user inputs. |
| Rail Receiving Area | The area of the rail receiving area. |
| Rail Receiving Hskpng Freq | The frequency of housekeeping per month |
| | for rail receiving. |
| Rail Receiving | This field is computed from user inputs. |
| Truck Loadout Area | The area for the truck loadout area. |
| Truck Loadout Hskpng Freq | The frequency of housekeeping per month |
| | for truck loadout. |
| Truck Loadout | This field is computed from user inputs. |
| Rail Loadout Area | Enter the area for the rail loadout area. |
| Rail Loadout Hskpng Freq | The frequency of housekeeping per month |
| | for rail loadout. |
| Rail Loadout | This field is computed from user inputs. |
| Boil/PMP/Elect Area | The size of the boiler/power area. |
| Boil/PMP/Elect Hskpng Freq | The frequency of housekeeping per month |
| | for the boiler/power area. |
| Boil/PMP/Elect | This field is computed from user inputs. |
| Truck Tunnel Area | The area of the truck terminal. |
| Truck Tunnel Hskpng Freq | The frequency of housekeeping per month |
| | for the truck tunnel. |
| Truck Tunnel | This field is computed from user inputs. |
| Rail Tunnel Area | The area of the rail terminal. |
| Rail Tunnel Hskpng Freq | The frequency of housekeeping per month |
| | for the rail tunnel. |
| Rail Tunnel | This field is computed from user inputs. |
| Maint Shop Area | The size of the maintenance shop. |
| Maint Shop Hskpng Freq | The frequency of housekeeping per month |
| | for the maintenance shop. |
| Maint Shop | This field is computed from user inputs. |
| Office/Employ Area | The area of the office/employee area. |
| Office/Employ Hskpng Freq | The frequency of housekeeping per month |
| | for the office/employee area. |
| Office/Employ | This field is computed from user inputs. |
| Parking Lot (Hrs/Mo) | The hours per month for cleaning the |
| | parking lot. |
| Mow/Snow Rmv (Hrs/Mo) | The hours per month for mowing/snow |
| | removal. |
| Mill | This field may be a constant rate. |
| Warehouse | This field may be a constant rate. |
| Blowdown | This field may be a constant rate. |
| Mezzanine area | The area of the mezzanine. |
| Mezzanine Hskpng Freq | Enter the frequency of housekeeping per |
| | month for the mezzanine area. |
| Mezzanine | This field is computed from user inputs. |
| Total Hrs/Day | This field is computed from user inputs. |
| Wages/Hr $ | Wages per hour of employees involved |
| | with the process. |
| Cost/Day $ | Cost per ton that the process adds to the |
| | product |
| Tot MIg Cost $ | Overall cost of milling |
| Autosweep (% UM) | This field may be a constant rate. |
| Other | The area for the user entered area. |
| Other Hskpng Freq | The frequency of housekeeping per month |
| | for the user entered area. |
| Other Area | The area for the user entered area. |

Housekeeping process data 110 may be based on areas or spaces within the facility (shown as “Bin Deck,” “Mill Floor A,” “Mill Floor B,”“Mezannine Area,” etc.), on the size of those spaces (e.g., square footage, etc.), and/or on the frequency that housekeeping processes should be conducted (e.g., frequency, occurrences, daily, monthly, number of days per month, etc.). Housekeeping process data may also be based on an estimated number of hours required to complete a task (e.g., mowing, snow removal, etc.). System 10 may calculate time required to complete the housekeeping processes (e.g., based on a given space size and cleaning rate) and the cost associated with the housekeeping processes. As well, other housekeeping data may be included depending on the facility, processes, and employees involved, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

c. General Plant

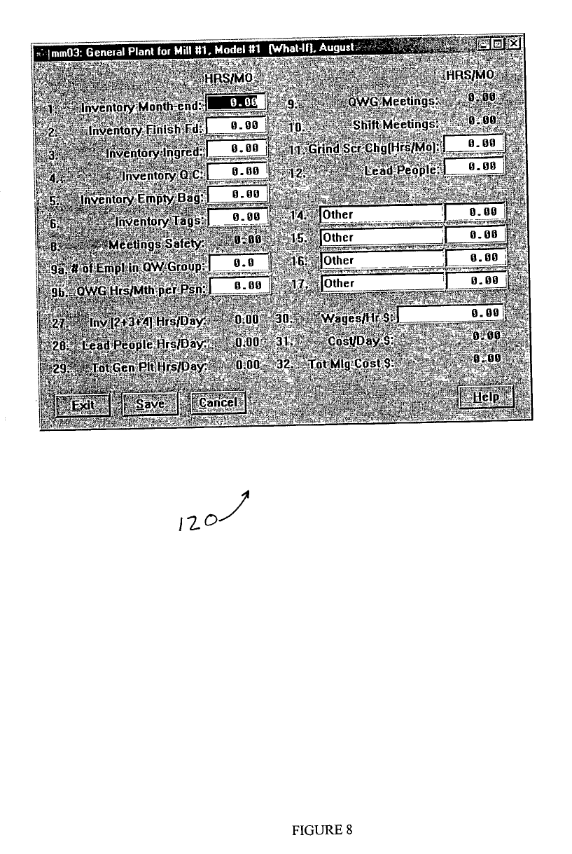

As shown in FIG. 8, general plant processes data 120 may include steps and model data associated with personnel time, hours associated with general plant or facilities operations, meetings, etc. General plant process data may include the time needed for the purposes of conducting month end inventories, to inventory both finished bagged products and bulk products, to inventory both bagged and bulk ingredients, to inventory empty bags for finished feed bagged production, to inventory feed tags, for formally held safety meetings, for quality work group meetings, for formally held shift meetings, for changes of grinder screens for the purpose of a grind size change, the time required of employees for the purpose of directing others or production process coordination, or other purposes. According to a particularly preferred embodiment, general plant processes data 120 comprises model data relating to a recurring meeting in facility including the number of employees needed/required for the recurring meeting, and an amount of time needed per employee for the recurring meeting. A total number of hours required for the recurring meeting may then be generated by multiplying the number of employees needed by the amount of time needed per employee. Other general plant data may be included, depending on the facility, processes, and employees involved, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

| Data | Description |
|---|---|
| Inventory Month-end | The hours required by hourly paid employees |
| | for the purposes of month end inventories. |
| | Typically these inventories are done by |
| | teams of 2 employees. |
| Inventory Finish Fd | The time required to inventory both finished |
| | bagged products and bulk products. |
| Inventory Ingred | The time required to inventory both bagged |
| | and bulk ingredients. |
| Inventory Q C | The time required daily to inventory both |
| | drugs and premixes. |
| Inventory Empty Bag | The time required to inventory empty bags |
| | for finished feed bagged production. |
| Inventory Tags | The time required to inventory feed tags. |
| Meetings Safety | This field is computed from user inputs. |
| | The time established for formally held safety |
| | meetings. |
| QWG Meetings | This field is computed from user inputs. |
| | The time established for formally held quality |
| | work group meetings. |
| Shift Meetings | This field is computed from user inputs. |
| | The time established for formally held shift |
| | meetings. |
| Grind Scr Chg(Hrs/Mo) | Any changes of hammermill screen for the |
| | purpose of a grind size changed. |
| Lead People | The time required of hourly paid employees |
| | for the purpose of directing others or |
| | production process coordination. |
| Inv [2 + 3 + 4] Hrs/Day | This field is computed from user inputs. |
| Lead People Hrs/Day | This field is computed from user inputs. |
| Tot Gen Plt Hrs/Day | This field is computed from user inputs. |
| Wages/Hr $ | Wages per hour of employees involved with |
| | the process. |
| Cost/Day $ | Cost per ton that the process adds to the |
| | product |
| Tot Mlg Cost $ | Overall cost of milling |
| # of Empl in QW Group | The number of employees in the Quality |
| | Work Group. |
| QWG Hrs/Mth per Psn | The hours per month per person in the |
| | Quality Work Group. |

d. Bag Receiving Process

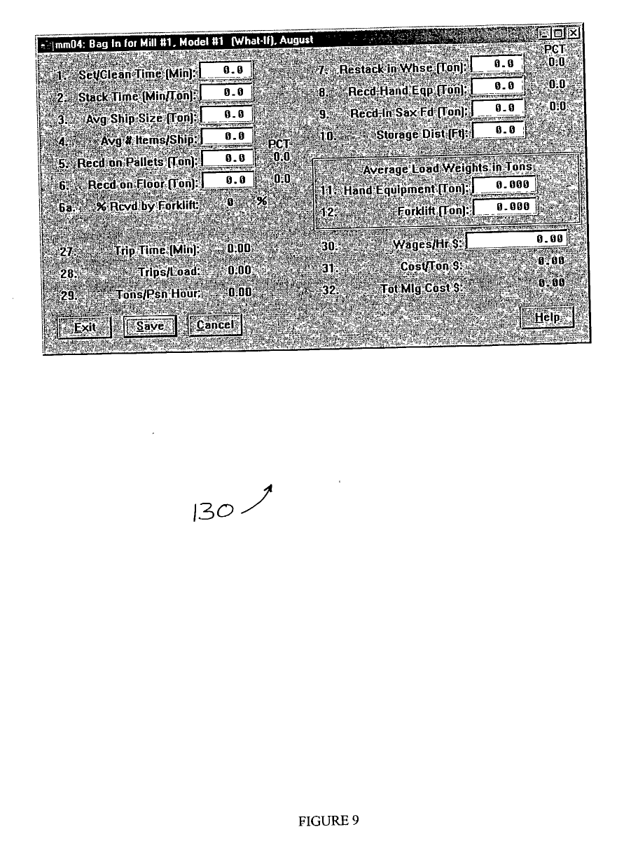

As shown in FIG. 9, bag receiving process data 130 may include steps and model data associated with receiving materials in a bag form. For example, in a facility producing feed products (such as animal feed products) or other food products, materials which are constituents or make up the feed product may be shipped in bags, containers, bins, etc. At the facility, the materials may be received and moved within the facility by hand, carts, pallet jacks, forklifts, conveyor belts, etc.

| Data | Description |
|---|---|
| Set/Clean Time (Min) | May be based on a time study, |
| | including time to: |
| | Set dock plate |
| | Check and handle paperwork |
| | Clean/arrange product bays |
| Stack Time (Min/Ton) | May be based on a time study of how |
| | long it takes to stack one ton of bags. |
| | (Min.), from the floor of the truck |
| | onto a handtruck or pallet |
| Avg Ship Size (Ton) | Divide the receiving tons by the total |
| | number of bag shipments received. |
| | Bag In (Tons) |
| | Shipments |
| Avg # Items/Ship | The number of items received and |
| | divided by the number of bag |
| | shipments received. |
| | Items Received |
| | Shipments |
| Recd on Pallets (Ton/Percentage) | Tons or percentage of materials |
| | received on pallets. |
| Label: Recd on Floor | Tons or percentage of materials |
| (Ton/Percentage) | received on floor. |
| Label: Restack in Whse (Ton) | Amount to be restacked on pallets. |
| Recd-Hand Eqp (Ton) | Amount received with hand |
| | equipment |
| Recd-In Sax Fd (Ton) | Amount received in sacks |
| Storage Dist (% UM) | The distance from receiving dock to |
| | weighted center (roughly weigh the |
| | effect of ingredient usage vs. |
| | distance) of ingredient storage |
| | (Ft or Meters) |
| Hand Equipment (Ton) | The average handtruck load (ton). |
| Trip Time (Min) | This field is computed from user |
| | inputs. |
| Trips/Load | This field is computed from user |
| | inputs. |
| Tons/Psn Hour | This field is computed from user |
| | inputs. |
| Wages/Hr $ | Wages per hour of employees |
| | involved with the process. |
| Cost/Ton $ | Cost per ton that the process adds to |
| | the product. |
| Tot Mlg Cost $ | Overall cost of milling. |
| % Rcvd by Forklift | This field is from user inputs |
| | The percent received by forklift. |

Bag receiving process data 130 may include time taken to unload trucks, handling of paperwork (shipping orders, receipts, loading orders, etc.), set/clean time (setting up and cleaning the area directly effected by bag receiving), and re-stacking time.

Bag receiving process data may include Set/Clean Time (Min) (e.g., an estimate of time needed to set the dock plate, Check and handle paperwork, and Clean/arrange product bays), Stack Time (Min/Ton) (e.g. an estimate of time needed to stack one ton of bags (Min.), from the floor of the truck onto a handtruck or pallet), Avg Ship Size (Ton) (e.g., the tons received divided by the total number of bag shipments received), Avg # Items/Ship (e.g, the number of items received divided by the number of bag shipments received), Recd on Pallets (e.g, tons of product received on pallets, percentage of tons of product received on pallets, etc.), Recd on Floor (e.g, tons of product received on the floor, percentage of tons of product received on floor, etc.), Restack in Whse (e.g., changing pallets), Recd-Hand Eqp (Ton) (may be expresses as tons or as a percentage of received bags, Recd-In Sax Fd, Storage Dist (% UM), Hand Equipment (Ton)(the average handtruck load (ton)), Forklift (the average forklift load (ton)), Trip Time (Min), Trips/Load, Tons/Psn Hour (e.g., tons per person hour), Wages/Hr $, Cost/Ton $, Tot Mlg Cost $, % Rcvd by Forklift, etc.

According to a particularly preferred embodiment, bag receiving process data 130 comprises model bag receiving data, data relating to an amount or percentage of bag material received with a forklift, and data relating to a capacity of the forklift. The percentage of bag material received with a forklift may be calculated by ((FIELD 5+FIELD 6)−FIELD 8)/(FIELD 5+FIELD 6)*100. As well, other calculations may be used depending on the desired results and the available inputs. Also, other bag receiving data may be included depending on the facility and processes involved, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

e. Bulk Receiving Process

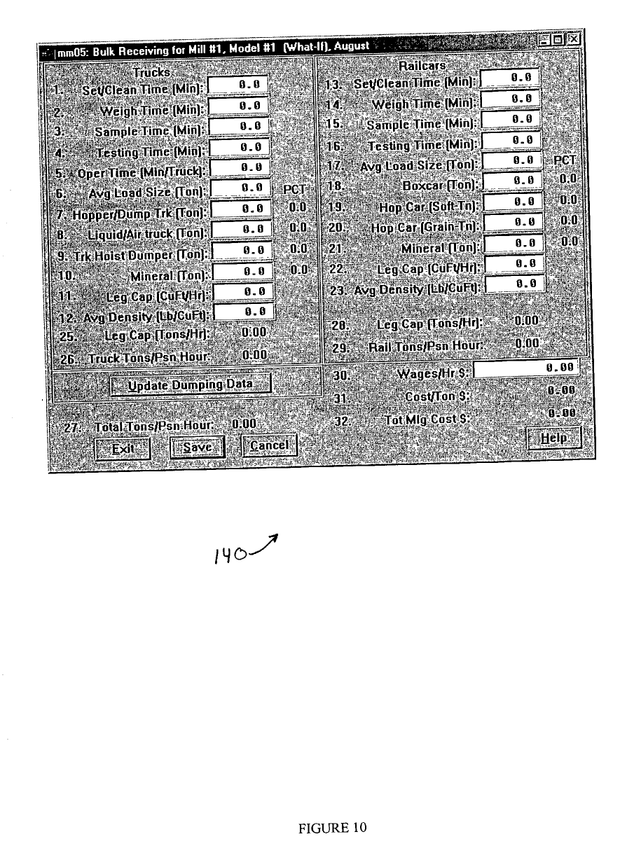

As shown in FIG. 10, bulk receiving process data 140 may include steps and model data associated with receiving material in bulk form (such as from rail cars and trucks). Bulk receiving process data 140 may include set/clean time (setting up and cleaning the area directly effected by bulk receiving), handling of paperwork, weight time, sample time, and testing time (for trucks and rail cars)

Bulk receiving process data may include the following data:

| Data | Description |
|---|---|
| Truck Set/Clean Time (Min) | May be based on a time study. |
| | Includes time to: |
| | Set Distribution |
| | Check/Handle paperwork |
| | Cleanup |
| | Travel time |
| | Open-Close car |
| Truck Weigh Time (Min) | This is the time required to weigh the |
| | unit in and out for receiving. |
| Truck Sample Time (Min) | This is the time required to sample the |
| | ingredient before unloading. |
| Truck Testing Time (Min) | This is the time required to conduct |
| | quality control tests on incoming |
| | ingredients. |
| Truck Oper Time (Min/Truck) | May be based on a time study. |
| | Includes time to: |
| | Check ingredient quality |
| | Monitor the progress on unload |
| Truck Avg Load Size (Ton) | Average amount of material received |
| | per truck load (e.g., total tons of |
| | material received per month divided |
| | by number of trucks per month. |
| Truck Hopper/Dump Trk | Amount or percentage of material |
| (Ton/Percentage) | received by truck hopper and dump |
| | truck. |
| Truck Liquid/Air Truck | Amount or percentage of liquid or gas |
| (Ton/Percentage) | material received by truck. |
| Truck Hoist Dumper (Ton/ | Amount or percentage of material |
| Percentage) | received by trucks which are unloaded |
| | by a hydraulically operated dumper |
| | unit or scale. |
| Truck Mineral (Ton/Percentage) | Amount or percentage of mineral |
| | material received by truck hopper and |
| | dump truck. |
| Truck Leg Cap | Capacity of leg(s) operating on truck |
| | bulk receiving process. |
| Truck Avg Density | Average density of material received |
| | in trucks. |
| Truck Leg Cap (Tons/Hr) | This field is computed from user |
| | inputs. |
| Truck Tons/Psn Hour | This field is computed from user |
| | inputs. |
| Truck Total Tons/Psn Hour | This field is computed from user |
| | inputs. |
| Railcars Set/Clean Time (Min) | May be based on a time study. |
| | Includes time to: |
| | Set distribution |
| | Check/Handle paperwork |
| | Cleanup |
| | Set and move car (one or more |
| | times) |
| | Travel Time |
| | Open-Close car |
| Railcars Weigh Time (Min) | This is the time required to weigh the |
| | unit in and out for receiving. |
| Railcars Sample Time (Min) | This is the time required to sample |
| | the ingredient before unloading. |
| Railcars Testing Time (Min) | This is the time required to conduct |
| | quality control tests on incoming |
| | ingredients. |
| Railcars Avg Load Size (Ton) | Average amount of material received |
| | per railcar load (e.g., total tons of |
| | material received per month divided |
| | by number of railcars per month. |
| Railcars Boxcar (Ton/ | Amount or percentage of material |
| Percentage) | received by boxcar. |
| Railcars Hop Car (Soft-Tn/ | Amount or percentage of material |
| Percentage) | received by hop cars. |
| Railcars Hop Car (Grain-Tn/ | Amount or percentage of material |
| Percentage) | received by hop cars. |
| Railcars Mineral (Ton) | Amount or percentage of mineral |
| | material received. |
| Railcars Leg Cap (% UM) | Capacity of leg(s) operating on truck |
| | bulk receiving process. |
| Railcars Avg Density (% UM) | Average density of material received |
| | in trucks. |
| Railcars Leg Cap (Tons/Hr/ | This field is computed from user |
| Percentage) | inputs. |
| Railcars Rail Tons/Psn Hour | This field is computed from user |
| | inputs. |
| Wages/Hr $ | Wages per hour of employees |
| | involved with the process. |
| Cost/Ton $ | Cost per ton that the process adds to |
| | the product |
| Tot Mlg Cost $ | Overall cost of milling |

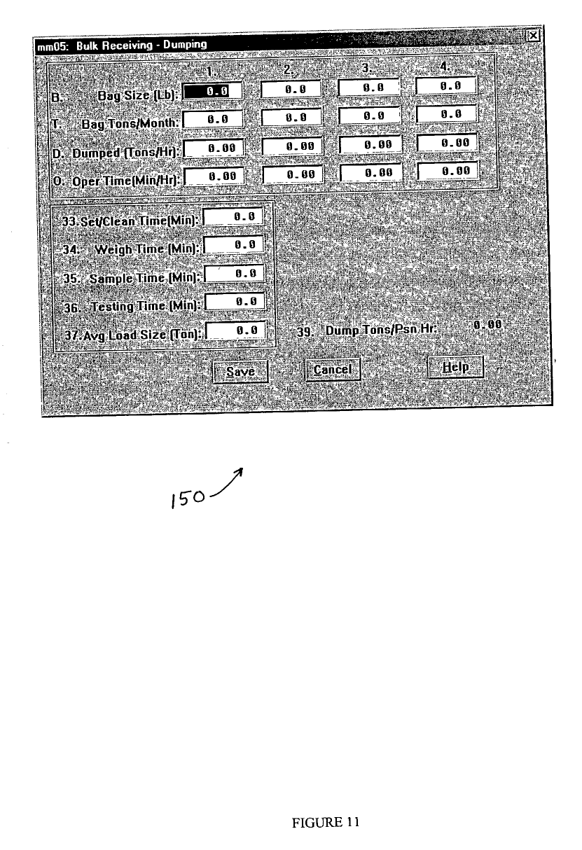

According to a particularly preferred embodiment, bulk receiving process data 140 comprises model dumping data. For example, as shown in FIG. 11, model dumping data 150 may comprise data related to transferring material received in bags (such as large “one-ton-totes”) into a bulk storage area. For example, the process may involve emptying material from these bags into holding areas. As shown in FIG. 11, model dumping data may relate to the size of one or more bags, bag tons per month, dumped tons (tons/hour), operator time, set times, clean times, weigh times, sample times, testing times, and average load size.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

f. Mixing Process Data

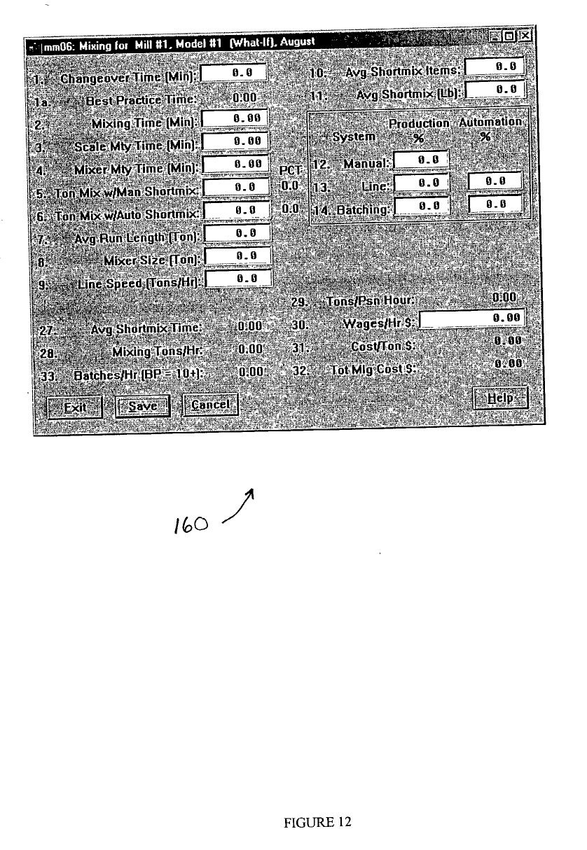

As shown in FIG. 12, mixing process data 160 may include steps and model data associated with mixing various materials and products together to form products. Mixing process data may include changeover time, mixing time, short mixing (getting ingredients, and weighing), recording drug and premix usage, and completing mixing process improvement sheets.

Mixing process data may include the following data:

| Data | Description |
|---|---|
| Changeover Time (Min) | May be based on a time study. This is the |
| | time between stopping one run and starting |
| | another: Includes time to: |
| | Get formula |
| | Get shortmix items |
| | Cleanup per run |
| | Set distribution |
| | Paperwork |
| Best Practice Time | This field is computed from user inputs. |
| Mixing Time (Min) | May be based on a mixer efficiency study to |
| | find the minimum mixing time (Min.). |
| Scale Mty Time (Min) | Timed value of how long it takes to empty a |
| | scale (Min.). |
| Mixer Mty Time (Min) | Timed value of how long it takes to empty a |
| | mixer (Min.). |
| Avg Run Length (Ton) | The mixing tons divided by the runs during |
| | the same period (Tons). |
| Mixer Size (Ton) | The size or capacity of a mixer (Tons). |
| Line Speed (Tons/Hr) | The tons per hour of continuous mix |
| | operations. |
| Avg Shortmix Items | Average-weight of shortmix items (e.g., |
| | typically small, hand-added ingredients). |
| Ton Mix w/Man | Manual shortmix tons are the shortmix items |
| Shortmix/Percentage | that are weighed by an operator and |
| | manually dumped. Includes the tons |
| | weighed/dumped manually. |
| Ton Mix w/Auto | Automatic shortmix tons includes the |
| Shortmix/Percentage | shortmix that is added to product mix |
| | automatically by machine. Includes the tons |
| | added automatically. |
| Avg Shortmix (% UM) | The bag ingredients divided by the tons |
| | mixed then multiply by mixer size (Pounds or |
| | Kilograms per Batch. |
| Manual (Production %) | The percent of production that is mixed with |
| | a manual system. |
| Line (Production %) | The percent of production that is mixed with |
| | a line system. |
| Line (Automation %) | The percent of automation of production for |
| | the line system. |
| Batching | The percent of production that is mixed with |
| (Automation %) | a batching system. |
| Avg Shortmix Time | Average shortmix time |
| (Percentage) | |
| Mixing Tons/Hr | Mixing tons per hour |
| (Percentage) | |
| Tons/Psn Hour | Tons per person hour |
| (Percentage) | |
| Wages/Hr $ | Wages per hour of employees involved with |
| | the process. |
| Cost/Ton $ | Cost per ton that the process adds to the |
| | product. |
| Tot Mlg Cost $ | Overall cost of milling. |
| Batches/Hr (BP = 10+) | This field is computed from user inputs. |

According to a particularly preferred embodiment, mixing process data 160 comprises best practice time (e.g., mixing time plus scale emptying time plus mixer empty time) and batches/hour (e.g., mixing tons/hour divided by mixer size). As well, other mixing process data may be included depending on the facility and the processes involved, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

g. Dry Packing Process And Wet Packing Process

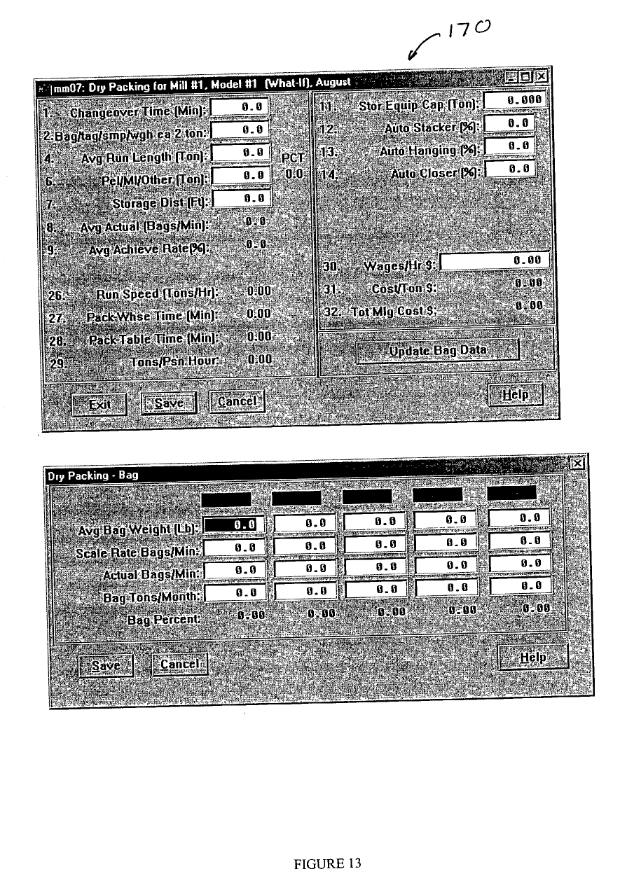

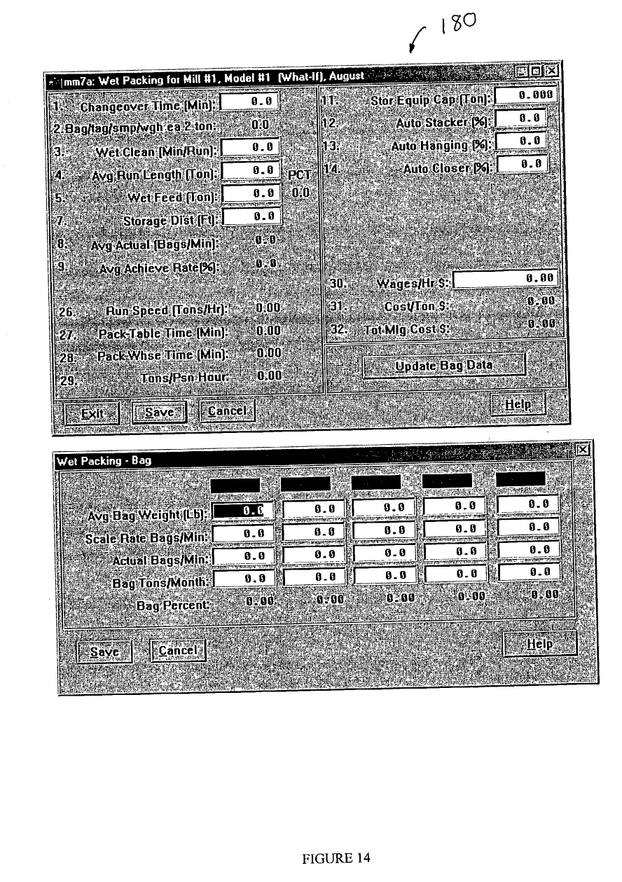

As shown in FIGS. 13 and 14, dry packing process data 170 and wet packing process data 180 may include steps and model data associated with packing both wet and dry products into containers, bags, bulk containers, etc. Dry packing process data 170 may include bagging, storage distribution, sampling, changeover time, getting bags and tags, and completing packing process control sheets

Dry packing and wet packing process data may include the following data:

| | |
|---|---|
| Data | Description |

DRY PACKING PROCESS:

| | |
|---|---|
| Changeover Time (Min) | May be based on a time study (Min.). |
| | This is the time between stopping one |
| | run and starting another run. Time may |
| | be multiplied by two to calculate the |
| | labor time needed. (Multiplying by two |
| | is for purposes of including both the |
| | packing and table employees). Includes |
| | time to: |
| | Open/Close and vibrate bin |
| | Get tag/bag supply |
| | Paperwork |
| | Cleanup |
| | Bay time |
| Bag/tag/smp/wgh ea 2 ton | May be based on a time study (Min.). |
| | This is the time required to reload |
| | empty bags, reload tags, sample run, or |
| | test weigh bags once per every two |
| | ton. Includes time to: |
| | Restock bags (80 bags) |
| | Restock tags (80 tags) |
| | Sample feed |
| | Check weigh bag |
| | Adjust scale |
| Avg Run Length (Ton) | The packing tons divided by the number |
| | of runs packed during that period |
| | (Tons). |
| Pel/Ml/Other (Ton/Percentage) | The total tons of all dry feeds packed. |
| | (Pellet, meal and other). |
| Storage Dist (% UM) | Average distance operators need to |
| | travel (one way) to get to a warehouse |
| | bay. |
| Avg Actual (Bags/Min) | This field is computed from user inputs. |
| Avg Achieve Rate(%) | This field is computed from user inputs. |
| Stor Equip Cap (Ton) | Equipment capacity of forklifts, hand |
| | trucks, etc. Forklifts may be one ton |
| | and hand trucks may be 1/4 ton. |
| Auto Stacker (%) | The percent of product that is handled |
| | with an auto stacker. |
| Auto Hanging (%) | The percent of product that is handled |
| | with an auto hanger. |
| Auto Closer (%) | The percent of product that is handled |
| | with an auto closer. |
| Run Speed (Tons/Hr) | This field is computed from user inputs. |
| Pack-Whse Time (Min) | This field is computed from user inputs. |
| Pack-Table Time (Min) | This field is computed from user inputs. |
| Wages/Hr $ | Wages per hour of employees involved |
| | with the process. |
| Tons/Psn Hour | Cost per ton that the process adds to |
| | the product |
| Cost/Ton $ | Overall cost of milling. |
| Tot Mlg Cost $ | This field is computed from user inputs. |

WET PACKING PROCESS:

| | |
|---|---|
| Changeover Time (Min) | May be based on a time study (Min.). |
| | This is the time between stopping one |
| | run and starting another run. Time may |
| | be multiplied by two to calculate the |
| | labor time needed. (Multiplying by two |
| | is for purposes of including both the |
| | packing and table employees). Includes |
| | time to: |
| | Open/Close and vibrate bin |
| | Get tag/bag supply |
| | Paperwork |
| | Cleanup |
| | Bay time |
| Bag/tag/smp/wgh ea 2 ton | May be based on a time study (Min.). |
| | This is the time required to reload |
| | empty bags, reload tags, sample run, or |
| | test weigh bags once per every two |
| | ton. Includes time to: |
| | Restock bags (80 bags) |
| | Restock tags (80 tags) |
| | Sample feed |
| | Check weigh bag |
| | Adjust scale |
| Wet Clean (Min/Run) | Clean scale and miscellaneous |
| | equipment after running wet feed |
| | (Min.). This is the time required to |
| | clean the scale and work area after a |
| | wet feed run. |
| Avg Run Length (Ton) | The packing wet tons divided by the |
| | number of runs packed during that |
| | period (Tons). |
| Wet Feed (Ton) Percentage | The total tons (or percentage) of all. wet |
| | feeds. |
| Storage Dist (% UM) | Average distance operators need to |
| | travel (one way) to get to a warehouse |
| | bay. |
| Avg Actual (Bags/Min) | |
| Avg Achieve Rate(%) | |
| Stor Equip Cap (Ton) | Equipment capacity of forklifts, hand |
| | trucks, etc. Forklifts may be one ton |
| | and hand trucks may be 1/4 ton. |
| Auto Stacker (%) | The percent of product that is handled |
| | with an auto stacker. |
| Auto Hanging (%) | The percent of product that is handled |
| | with an auto hanger. |
| Auto Closer (%) | The percent of product that is handled |
| | with an auto closer. |
| Run Speed (Tons/Hr) | This field is computed from user inputs. |
| Pack-Whse Time (Min) | This field is computed from user inputs. |
| Pack-Table Time (Min) | This field is computed from user inputs. |
| Tons/Psn Hour | This field is computed from user inputs. |
| Wages/Hr $ | Wages per hour of employees involved |
| | with the process. |
| Cost/Ton $ | Cost per ton that the process adds to |
| | the product. |
| Tot Mlg Cost $ | Overall cost of milling. |

According to a particularly preferred embodiment, dry packing process data and wet packing process data 170 and 180 comprise model dry packing data, model wet packing data, wet and dry packing efficiency, bag size data (e.g., one or two or more bag sizes), average bag weight, scale rate of number of bags per time, scale rate of number of bags per minute, actual rate of bags per time, actual rate of bags per minute, bag tons per month, a manufacturer specification for at least one piece of packing equipment (such as automated packing equipment), liquid addition time, setup time and clean up time. As well, other information relating to the dry packing processes and the wet packing processes may be included depending on the facility and the processes involved, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

h. Bulk Load Out Process and Bag Load Out Process

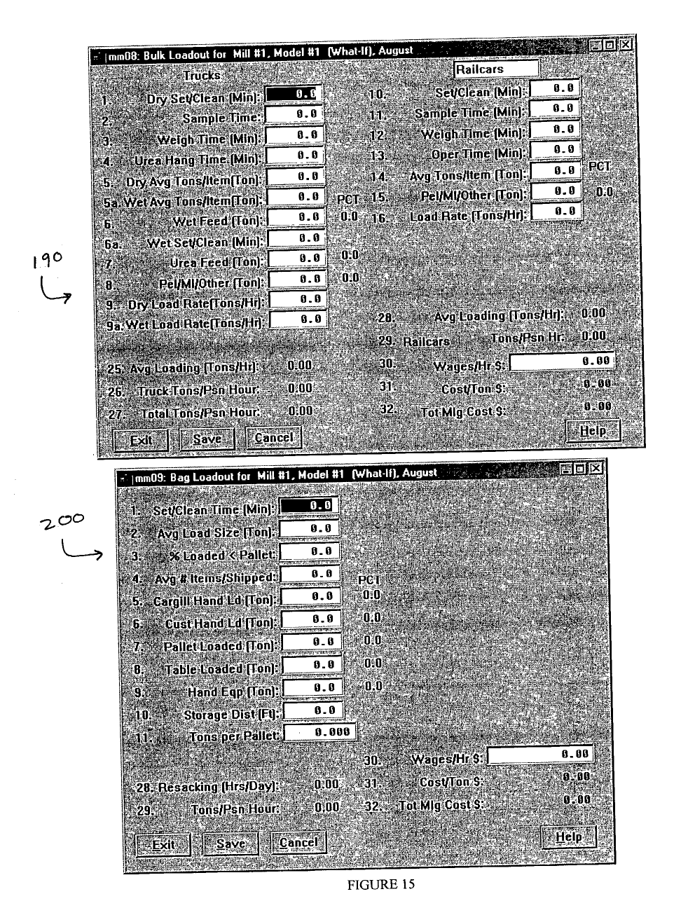

As shown in FIG. 15, bulk load out process data 190 and bag load out process data 200 may include steps and model data associated with loading trucks, railcars and other transports with product, or other steps involved with shipping product. Bag load out may include set/clean time (setting up and cleaning areas directly effected by bag loading), truck loading time, handling paperwork, resacking and handling broken bags. Bulk load out may include set/clean time (setting up and cleaning areas directly effected by bulk loading), truck loading time, sample time, weigh time, and handling paperwork for trucks and rail cars.

Bulk load out and bag load out process data may include the following data:

| | |
|---|---|
| Data | Description |

BULK LOADOUT PROCESS:

| | |
|---|---|
| Dry Set/Clean (Min) | May be based on a time study. Time |
| | required to set up, complete paperwork, |
| | and cleanup after loading one feed. |
| | Includes: |
| | Time to position unit for loading |
| | Paperwork |
| | Travel time |
| Sample Time | Time it takes to sample each single feed |
| | after loading (Min.). |
| Weigh Time (Min) | Time it takes to weigh a truck both in and |
| | out for each single feed or obtain rail |
| | weight for each feed. |
| Urea Hang Time (Min) | Time during which an operator needs to |
| | vibrate a bin to release a hang for urea |
| | feeds. |
| Dry Avg Tons/Item(Ton) | Bulk warehousing tons divided by the |
| | difference in the “Scale Ticket” numbers |
| | during this period. |
| | Bulk Warehouse Tons (Truck only)/ |
| | (Ending Scale Ticket Number - Beginning |
| | Scale Ticket Number) |
| Wet Feed (Ton) (Percentage) | Average wet feed bulk tons. |
| Urea Feed (Ton) (Percentage) | Average urea feed bulk tons. |
| Pel/Ml/Other (Ton) | Bulk warehouse tons and subtract wet and |
| Percentage | urea feed tons. |
| Dry Load Rate(Tons/Hr) | Time of loading rate per ton once the |
| | product is free flowing. |
| Set/Clean (Min) | May be based on a time study (Min.). |
| | Time required to set up, complete |
| | paperwork, and cleanup after loading one |
| | feed. Includes: |
| | Time to position unit for loading |
| | Paperwork |
| | Travel time |
| Sample Time (Min) | Time to sample each single feed after |
| | loading (Min.). |
| Weigh Time (Min) | Time to weigh a truck both in and out for |
| | each single feed or obtain rail weight for |
| | each feed. |
| Oper Time (Min) | May be based on a time study (Min.). This |
| | is the time required for an operator to load |
| | out feed. Includes time to: |
| | Check finish feed quality |
| | Monitor the progress of loading |
| | Automatic Loading: (Rail) |
| | No time allowed |
| | Truck Loading: (Given) |
| | Time to load at loading rate. |
| Avg Tons/Item (Ton) | Bulk tons of feed loaded into railcars |
| | divided by the number of different items |
| | shipped by rail. |
| | Bulk Warehouse Tons (Rail only)/ |
| | Number of items shipped |
| Pel/Ml/Other (Ton) | Bulk warehouse tons and subtract wet and |
| Percentage | urea feed tons. |
| Load Rate (Tons/Hr) | Time of loading rate per ton once the |
| | product is free flowing. |
| Avg Loading (Tons/Hr) | This field is computed from user inputs. |
| Truck Tons/Psn Hour | This field is computed from user inputs. |
| Total Tons/Psn Hour | This field is computed from user inputs. |
| Avg Loading (Tons/Hr) | This field is computed from user inputs. |
| Tons/Psn Hr | This field is computed from user inputs. |
| Wages/Hr $ | Wages per hour of employees involved |
| | with the process. |
| Cost/Ton $ | Cost per ton that the process adds to the |
| | product. |
| Tot Mlg Cost $ | Overall cost per ton of product. |
| Wet Avg Tons/ltem(Ton) | Divide the wet bulk warehousing tons by |
| | the difference in the “Scale Ticket” |
| | numbers during this period. |
| | Bulk Warehouse Tons (Truck only)/ |
| | (Ending Scale Ticket Number - Beginning |
| | Scale Ticket Number) |
| | NOTE: Railcar loading needs to be backed |
| | out of the bulk warehouse tons to make |
| | this calculation. |
| Wet Set/Clean (Min) | May be based on a time study. Time |
| | required to set up, complete paperwork, |
| | and cleanup after loading one feed. |
| | Includes: |
| | Time to position unit for loading |
| | Paperwork |
| | Travel time |
| Wet Load Rate(Tons/Hr) | Time of loading rate per ton once the |
| | product is free flowing. |

BAG LOADOUT PROCESS:

| | |
|---|---|
| Set/Clean Time (Min) | Time required to set up, to load a |
| | customer and cleanup afterward. May |
| | be based on a time study (Min.). |
| | May include time to: |
| | Set dock plate |
| | Check and handle paperwork |
| | Travel time |
| | Set chocks |
| Avg Load Size (Ton) | Average load size |
| % Loaded < Pallet | Capacity of a forklift or handtruck |
| Avg # Items/Shipped | Average the number of items per load. |
| Avg # Items/Shipped | Average the number of items per load. |
| Cargill Hand Ld (Ton/ | The tons of product loaded by Cargill. |
| Percentage) | |
| Cust Hand Ld (Ton/ | The tons of product loaded by the |
| Percentage) | customer. |
| Pallet Loaded (Ton/ | The tons of product loaded by pallet. |
| Percentage) | |
| Table Loaded (Ton/ | The tons of product TABLE LOADED. |
| Percentage) | |
| Hand Eqp (Ton/Percentage) | The tons of product loaded with hand |
| | equipment. |
| Storage Dist (% UM) | The average length the operators need to |
| | travel (one way) to get to a warehouse |
| | bay. |
| Resacking (Hrs/Day) | Time required to re-sack broken bags. |
| Tons per Pallet | The tons loaded per pallet. |
| Wages/Hr $ | Wages per hour of employees involved |
| | with the process. |
| Cost/Ton $ | Cost per ton that the process adds to the |
| | product. |
| Tot Mlg Cost $ | Overall cost of milling. |

According to a particularly preferred embodiment, bulk load out and bag load out process data 190 and 200 comprise model load out data, data relating to a set time for a rail car, a clean time for a rail car, a sample time for a rail car, a weigh time for a rail car, an OPER rate for a rail car, a load rate for a rail car, wet clean rate, wet load rate, wet average tons per item, and a resacking rate. Bulk load out and bag load out may include other data depending on the facility and materials being handled, among other factors. Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

i. Pelleting Process

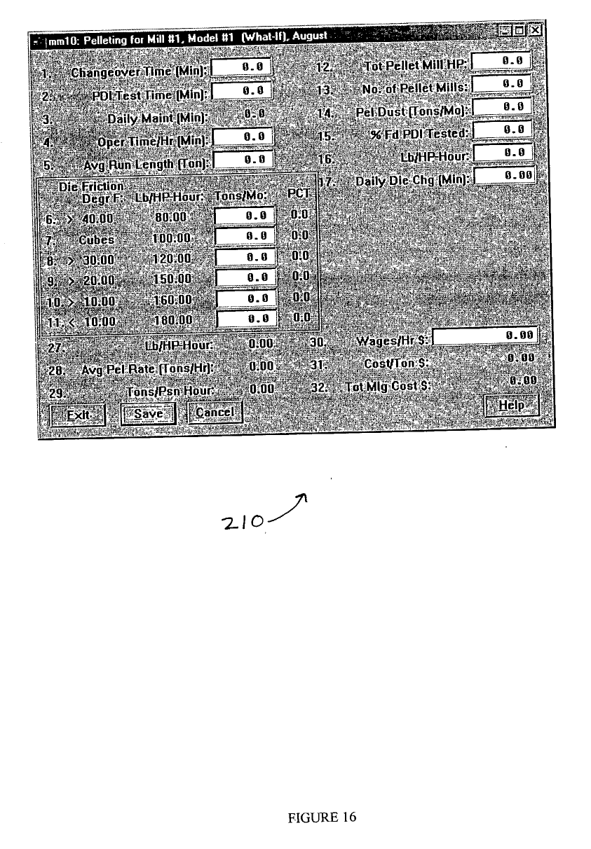

As shown in FIG. 16, pelleting process data 210 may include steps and model data associated with producing products in pellet form. Pelleting process data may include changeover time, pelleting, PDI testing, die changes, pellet dusting, daily maintenance, and pelleting process control sheets.

Pelleting process data may include:

| | |
|---|---|
| Changeover Time (Min) | Time between stopping one run and |
| | starting another run. May be based on a |
| | time study (Min.). Time may include: |
| | Travel time |
| | Set distribution |
| | Startup |
| | Sample and check quality |
| | Fill in records |
| | Shut down |
| | Run fines |
| | Cleanup floor |
| PDI Test Time (Min) | Time to get a sample and run a PDI test |
| | (pellet density index). Time may not |
| | include when the sample is unsupervised |
| | while in the tumbling chamber. |
| Daily Maint (Min) | Daily maintenance time in minutes/pellet |
| | mill/shift. This time may be deducted |
| | from time available to pelleting. This may |
| | be the sum total of daily maintenance for |
| | all mills. |
| Oper Time/Hr (Min) | Time the operator spends monitoring a |
| | single unit. May be based on a time study |
| | (Min.). Time may include: |
| | Travel time |
| | Check amps, feeder, feed quality, and |
| | adjust mill as needed |
| | Inspect cooler |
| | Discuss operation with others |
| Avg Run Length (Ton) | Divide the actual pellet tons by the runs |
| | during the same period (Tons). |
| 40+ | The tons pelleted using a 40+ mm die |
| | size. |
| Cubes | The tons pelleted into cubes. |
| 30 + | The tons pelleted using a 30+ mm die |
| | size. |
| 20+ | The tons pelleted using a 20+ mm die |
| | size. |
| 10+ | The tons pelleted using a 10+ mm die |
| | size. |
| Tot Pellet Mill HP | The pellet mill horsepower available at |
| | facility. This is maindrive motors only. |
| No. of Pellet Mills | The number of pellet mills available at |
| | facility. |
| Pel Dust (Tons/Mo) | Pellet dusting time |
| % Fd PDI Tested | The percent of feeds requiring PDI testing. |
| % UM | An entry here will override the computed |
| | value shown for field |
| Daily Die Chg (Min) | This field is computed from user inputs. |
| % UM | This field is computed from user inputs. |
| Avg Pel Rate (Tons/Hr) | This field is computed from user inputs. |
| Tons/Psn Hour | This field is computed from user inputs. |
| Wages/Hr $ | Wages per hour of employees involved |
| | with the process. |
| Cost/Ton $ | Cost per ton that the process adds to the |
| | product.. |
| Tot Mlg Cost $ | Overall cost of milling. |
| % UM | This field is computed from user inputs. |

According to a particularly preferred embodiment, pelleting process data 190 comprises model pelleting data, pelleting data relating to die friction, throughput of a pelleting machine, energy cost of the pelleting machine, or a time required to change a die of a pelleting machine. Other pelleting process data may also be included depending on the facility and the materials being handled, among other factors. Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

j. Maintenance Process

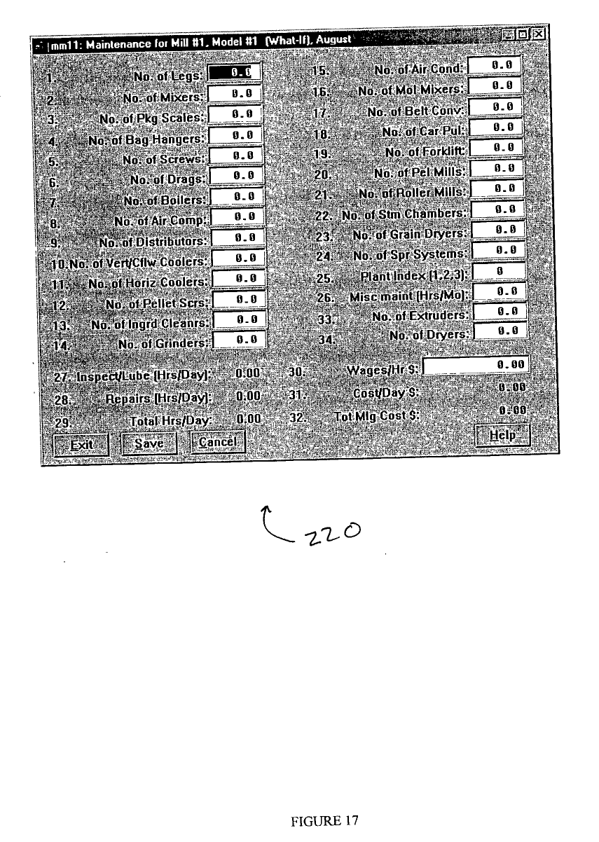

As shown in FIG. 17, maintenance process data 220 may include steps and model data associated with maintenance of facility equipment. Maintenance process data may include lubes, inspections, repairs (planned and unexpected), parts ordering, equipment history, and file maintenance.

Maintenance process data may include

| DATA | DESCRIPTION |
|---|---|
| No. of Legs | Number of Legs actively used and |
| | maintained. |
| No. of Mixers | Number of Mixers actively used and |
| | maintained. |
| No. of Pkg Scales | Number of Package Scales actively used |
| | and maintained. |
| No. of Bag Hangers | Number of Bag Hangers actively used and |
| | maintained. |
| No. of Screws | Number of Screws actively used and |
| | maintained. |
| No. of Drags | Number of Drags actively used and |
| | maintained. |
| No. of Boilers | Number of Boilers actively used and |
| | maintained. |
| No. of Air Comp | Number of Air Compressors actively used |
| | and maintained. |
| No. of Distributors | Number of Distributors actively used and |
| | maintained. |
| No. of Vert/Cflw Coolers | Number of Vertical/Counterflow Coolers |
| | actively used and maintained. |
| No. of Horiz Coolers | Number of Horizontal Coolers actively used |
| | and maintained. |
| No. of Pellet Scrs | Number of Pellet screeners actively used |
| | and maintained. |
| No. of Ingrd Cleanrs | Number of Ingredient Cleaners actively |
| | used and maintained. |
| No. of Grinders | Number of Grinders actively used and |
| | maintained. |
| No. of Air Cond | Number of Air Conditioners actively used |
| | and maintained. |
| No. of Mol Mixers | Number of Molasses Mixers actively used |
| | and maintained. |
| No. of Belt Conv | Number of Belt Conveyors actively used |
| | and maintained. |
| No. of Car Pul | Number of Car Pul actively used and |
| | maintained. |
| No. of Forklift | Number of Forklifts actively used and |
| | maintained. |
| No. of Pel Mills | Number of Pellet Mills actively used and |
| | maintained. |
| No. of Roller Mills | Number of Roller Mills actively used and |
| | maintained. |
| No. of Stm Chambers | Number of Steam Chambers actively used |
| | and maintained. |
| No. of Grain Dryers | Number of Grain Dryers actively used and |
| | maintained. |
| No. of Spr Systems | Number of Sprinkler Systems actively used |
| | and maintained. |
| Plant Index (1,2,3) | Number which best represents the |
| | mechanical complexity of the plant as |
| | follows: |
| | 1 - small plant |
| | 2 - medium plant |
| | 3 - large plant |
| Misc maint (Hrs/Mo) | |
| Inspect/Lube (Hrs/Day) | This field is computed from user inputs. |
| Repairs (Hrs/Day) | This field is computed from user inputs. |
| Total Hrs/Day | This field is computed from user inputs. |
| Wages/Hr $ | Wages per hour of employees involved |
| | with the process. |
| Cost/Day $ | Cost per ton that the process adds to the |
| | product. |
| Tot Mlg Cost $ | Overall cost of milling. |
| No. of Extruders | Number of Extruders actively used and |
| | maintained. |
| No. of Dryers | Number of Dryers actively used and |
| | maintained. |

According to a particularly preferred embodiment, maintenance process data 220 comprises model maintenance data, data relating to one of a number of extruders, and a number of dryers. As well, other maintenance data may be included depending on the facility and machinery being used, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

k. Energy Process

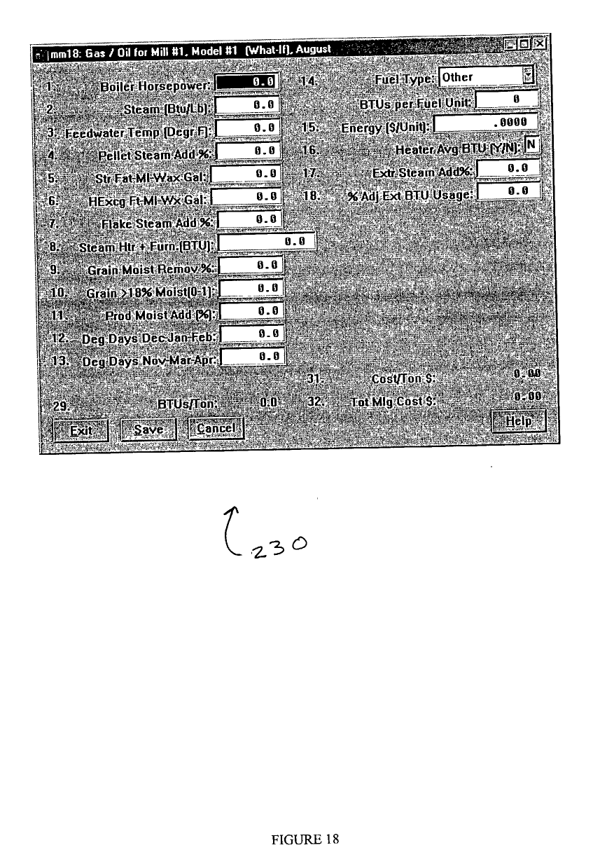

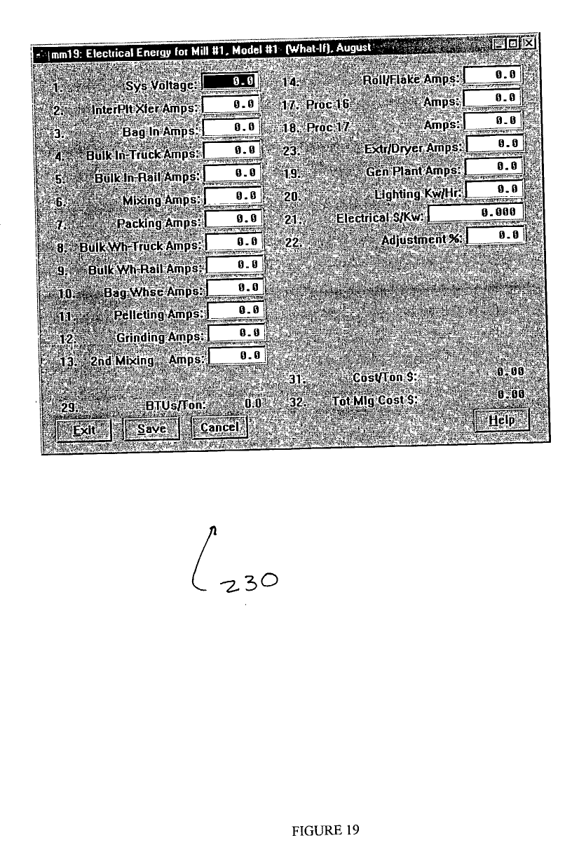

As shown in FIGS. 18 and 19, energy process data 230 may include steps and model data associated with gas/oil consumption and/or electrical consumption at a facility.

Energy process data may include data relating to electrical, gas and oil use such as:

| DATA | DESCRIPTION |
|---|---|
| Sys Voltage | Plant is typically on a 230, 460, or 575 |
| | voltage system. Electrical usage may be |
| | calculated for 3 phase equipment, or other |
| | configurations. |
| InterPlt Xfer Amps | Amperage of each motor (AMPS). |
| Bag In Amps | Amperage of each motor (AMPS). |
| Bulk In-Truck Amps | Amperage of each motor (AMPS). |
| Bulk In-Rail Amps | Amperage of each motor (AMPS). |
| Mixing Amps | Amperage of each motor (AMPS). |
| Packing Amps | Amperage of each motor (AMPS). |
| Bulk Wh-Truck Amps | Amperage of each motor (AMPS). |
| Bulk Wh-Rail Amps | Amperage of each motor (AMPS). |
| Bag Whse Amps | Amperage of each motor (AMPS). |
| Pelleting Amps | Amperage of each motor used for pelleting |
| | (AMPS). |
| Grinding Amps | Amperage of each motor (AMPS) used for |
| | grinding. |
| Amps | Amperage of each motor (AMPS). |
| Roll/Flake Amps | Amperage of each motor used for |
| | rolling/flaking (AMPS). |
| Amps | Amperage of each motor (AMPS). |
| Amps | Amperage of each motor (AMPS). |
| Gen Plant Amps | Amperage of each motor (AMPS). |
| Lighting Kw/Hr | The number of fixtures, kilowatts (KW) |
| | and percent usage during production |
| | hours. Total the weighted KW usage per |
| | hour. |
| Electrical $/Kw | Estimate or determination of the % of full |
| | amp load that plant typically electrically |
| | operate. |
| Adjustment % | |
| Extr/Dryer Amps | The amperage of each extruder/dryer |
| | motor (AMPS). |
| BTUs/Ton | This field is computed from user inputs. |
| Cost/Ton $ | This field is computed from user inputs. |
| Tot Mlg Cost $ | This field is computed from user inputs. |
| Boiler Horsepower | The total horsepower available (H.P.). |
| Steam (% UM) | NOTE: Use gage pressure values. |
| Feedwater Temp (% UM) | The temperature of feedwater coming into |
| | the makeup tank. |
| | This may be city or well water |
| | temperature. |
| Pellet Steam Add % | The percent of steam added at the pellet |
| | mill. |
| Str Fat-Ml-Wax % UM | The average gallons of liquid ingredients |
| | which are heated with water or steam |
| | (Gallons/Liters). |
| HExcg Ft-Ml-Wx % UM | The average gallons of liquid ingredients |
| | that pass through a heat exchanger. |
| Flake Steam Add % | May be from moisture tests to determine |
| | how much steam is being added to grain in |
| | the steam chamber (%). |
| Steam Htr + Furn. (BTU) | The connected BTU of steam heaters that |
| | are needed in the plant (BTU). |
| Grain Moist Remov % | May be from moisture tests to determine |
| | how much moisture is being removed |
| | during the grain drying process. |
| Grain > 18% Moist(0-1) | May be from moisture tests to determine |
| | the average moisture content of the |
| | incoming grain. If it is over 18% enter “1” |
| | may tell the computer to use the high |
| | moisture calculation. If the average |
| | moisture content is 18%, “0” may be |
| | entered. |
| Prod Moist Add (%) | May be from moisture tests to determine |
| | how much moisture is added during this |
| | process. Process 16 can be used for a |
| | moisture adding process as well as for |
| | grain drying. |
| Deg Days Dec-Jan-Feb | |
| Deg Days Nov-Mar-Apr | |
| BTUs per Fuel Unit | The BTU's per fuel unit of fuel for a boiler. |
| Energy ($/Unit) | The cost per unit for energy source. |
| Heater Avg BTU (Y/N) | Enter “Y” to calculate average Gas/Oil |
| | usage. This means that space heater fuel |
| | usage would be equally distributed over a |
| | 12 month calendar period. Enter “N” to |
| | calculate seasonal Gas/Oil usage for the |
| | current time frame utilizing the date typed |
| | at the start of program. |
| Extr Steam Add % | |
| % Adj Ext BTU Usage | |
| BTUs/Ton | BTUs required/estimated per ton of |
| | product. |
| Cost/Ton $ | Cost per ton that the process adds to the |
| | product |
| Tot Mlg Cost $ | Overall cost of milling |

According to a particularly preferred embodiment, energy process data 230 comprises model energy consumption data, gas consumption data, oil consumption data, electrical consumption data, energy amount associated with an extruding process, an energy amount associated with an extrusion screen, an additional amount of steam, an additional BTU usage, and wet packing amps. As well, other energy data may be used depending on the facility and the types of energy available, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

l. Miscellaneous Process

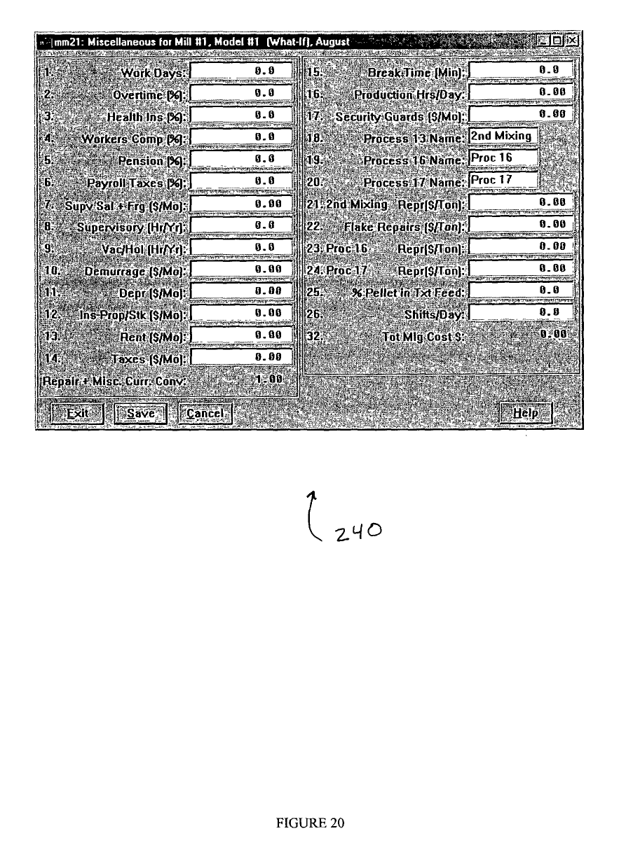

As shown in FIG. 20, miscellaneous process data 240 may include steps and model data associated with miscellaneous processes at a facility.

Miscellaneous process data may include

| DATA | DESCRIPTION |
|---|---|
| Work Days | The AVERAGE number of work days per |
| | month. Days that feed is PRODUCED. |
| | Maintenance days are not included. |
| Overtime (%) | Percent overtime. |
| Health Ins (%) | The cost of health insurance, as a |
| | PERCENTAGE of hourly wages. |
| Workers Comp (%) | The cost of Workers' Comp Insurance as a |
| | PERCENTAGE of hourly wages. |
| Pension (%) | Pension cost, expressed as a PERCENT of |
| | hourly wages. |
| Payroll Taxes (%) | The percent of total hourly wages paid to |
| | PAYROLL TAXES. |
| Supv Sal + Frg ($/Mo) | Monthly cost of supervisor salaries, plus |
| | some fringe benefits. |
| Supervisory (Hr/Yr) | Supervisor Hours per year. |
| Vac/Hol (Hr/Yr) | Annual vacation and holiday hours for |
| | hourly employees. |
| Demurrage ($/Mo) | Cost associated with delaying the |
| | unloading or loading or a transport such as |
| | a truck or a rail car. |
| Depr ($/Mo) | Depreciation expressed as dollars per |
| | month. |
| Ins-Prop/Stk ($/Mo) | |
| Rent ($/Mo) | |
| Taxes ($/Mo) | |
| Break Time (Min) | The time for A SINGLE BREAK at this |
| | facility, e.g. 15 minutes. The model will |
| | assume 2 breaks per day. |
| Production Hrs/Day | The NUMBER OF HOURS plant is running |
| | on an average production day. |
| Security Guards ($/Mo) | Cost per month for security guards. |
| Process 13 Name | The Operation synonymous with PROCESS |
| | 13 in the Model Mill. |
| Process 16 Name | The Operation synonymous with PROCESS |
| | 16 in the Model Mill. |
| Process 17 Name | The Operation synonymous with PROCESS |
| | 17 in the Model Mill. |
| Repr($/Ton) | Repair cost per ton to maintain this |
| | equipment. |
| Flake Repairs ($/Ton) | Dollars per ton required to maintain flake |
| | equipment. |
| Repr($/Ton) | Cost per ton required to repair/maintain |
| | Operaton 16 equipment. |
| Repr($/Ton) | Cost per ton for maintenance/repair of |
| | equipment used in Operation 17. |
| % Pellet in Txt Feed | If plant uses PREMIX PELLETS, the |
| | WEIGHTED AVERAGE of premix pellets |
| | used in textured feed. |
| Shifts/Day | The number of shifts per day. |
| Tot Mlg Cost $ | Total Milling Cost. |

According to a particularly preferred embodiment, miscellaneous process data 240 comprises model operations processes data, actual operations processes data, data relating to a cost associated with a security guard, or currency conversions to allow the system to convert various costs between different currencies. Further, other miscellaneous data may be included depending on the availability and desirability of such data, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

m. Contract Labor Process

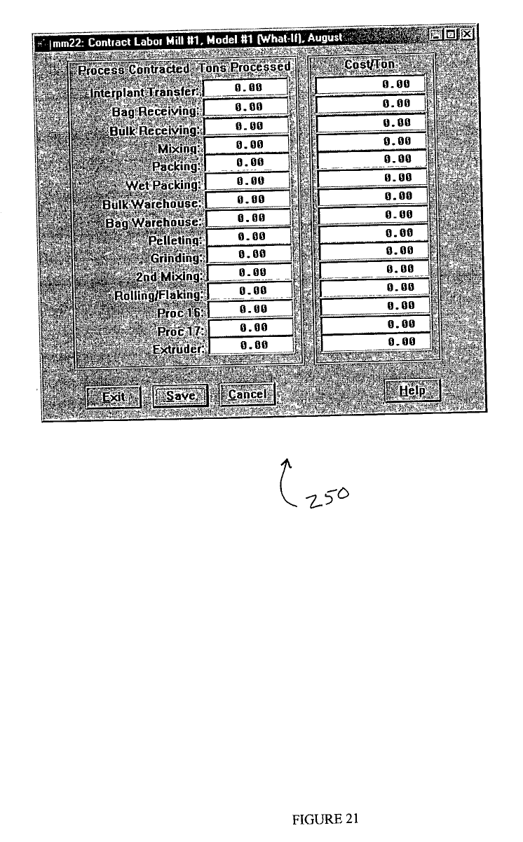

As shown in FIG. 21, contract labor process data 250 may include steps and model data associated with costs and amounts of materials handled by contract laborers or contract vendors.

Contract labor process data may include

| DATA | DESCRIPTION |
|---|---|
| Interplant Transfer | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Bag Receiving | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Bulk Receiving | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Mixing | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Packing | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Bulk Warehouse | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Bag Warehouse | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Pelleting | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Grinding | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Secondary Mixing | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Rolling/Flaking | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Process 16 | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Process 17 | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Extruder | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |
| Wet Packing | Data includes the contract-processed |
| | number of tons. The tons are included in |
| | the process tons entered on the |
| | corresponding process screen, not an |
| | addition to the process tons. Data also |
| | includes the cost per ton for the |
| | contracted process. |

According to a particularly preferred embodiment, contract labor process data 250 comprises model contract labor data (e.g., data relating to a cost or amount associated with contracting any one or more of the following: an interplant transfer, bag receiving, bulk receiving, mixing, packing, wet packing, bulk warehouse, bag warehouse, pelleting, grinding, second mixing, rolling, flaking, grain processing, block pressing, and extruding. Other contract labor data may be included depending on the labor arrangements for the facility, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

n. Extruding Process

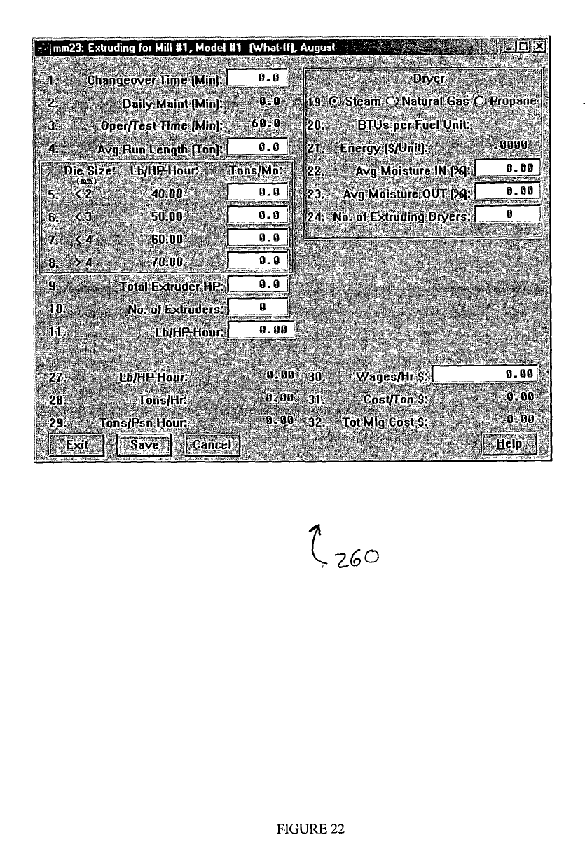

As shown in FIG. 22, extruding process data 260 may include steps and model data associated with producing products in extruded form.

| DATA | DESCRIPTION |
|---|---|
| Changeover Time (Min) | May be based on a time study (Min.). |
| | Includes time to: |
| | Travel time |
| | Set distribution |
| | Startup |
| | Sample and check quality |
| | Fill in records |
| | Shut down |
| | Run fines |
| | Cleanup floor |
| Daily Maint (Min) | This field is computed from user inputs. |
| Oper/Test Time (Min) | This field is computed from user inputs. |
| Avg Run Length (Ton) | Divide the extruder tons by the runs during |
| | the same period (Tons). |
| 2 mm > Die(Tons/Mo) | The tons extruded using a 2 mm > die |
| | size. |
| 2-3 mm Die(Tons/Mo) | The tons extruded using a 2-3 mm die |
| | size. |
| 3-4 mm Die(Tons/Mo) | The tons extruded using a 3-4 mm die |
| | size. |
| 4 mm < Die(Tons/Mo) | The tons extruded using a 4 mm < die |
| | size. |
| Total Extruder HP | The extruder horsepower available at the |
| | facility. |
| No. of Extruders | The number of extruders available at |
| | facility. |
| Fuel Type | The extruder's necessary fuel type. |
| BTUs per Fuel Unit | If “Other” is selected for mm 23_19, enter |
| | the BTUs per fuel unit for the fuel used by |
| | the extruder. |
| Energy ($/Unit) | The cost per unit for energy source. |
| Avg Moisture IN (%) | Average moisture percentage of product |
| | sample in. |
| Avg Moisture OUT (%) | Average moisture percentage of product |
| | sample out. |
| No. of Extruding Dryers | The number of extruding dryers available |
| | at facility. |
| % UM | This field is computed from user inputs. |
| Tons/Hr | This field is computed from user inputs. |
| Wages/Hr $ | Wages per hour of employees involved |
| | with the process. |
| Cost/Ton $ | Cost per ton that the process adds to the |
| | product |
| Tot Mlg Cost $ | Overall cost of milling |

According to a particularly preferred embodiment, extruding process data 260 comprises model extruding data (e.g., data relating to any one or more of the following: an energy cost associated with the extruding process, and a labor cost associated with the extruding process). As well, other extruding data may be used depending on the facility and extruding processes used, among other factors.

Model data may be provided for comparison to actual data for the process. The model data provided for comparison may be one or more inputted values, or one or more calculated values. According to a particularly preferred embodiment, the model data compared to the actual data may be a calculated value, based on inputted data, that is comparable to the actual data. For example, a model time, tons or run length may be provided that will be compared to the actual time, tons or run length.

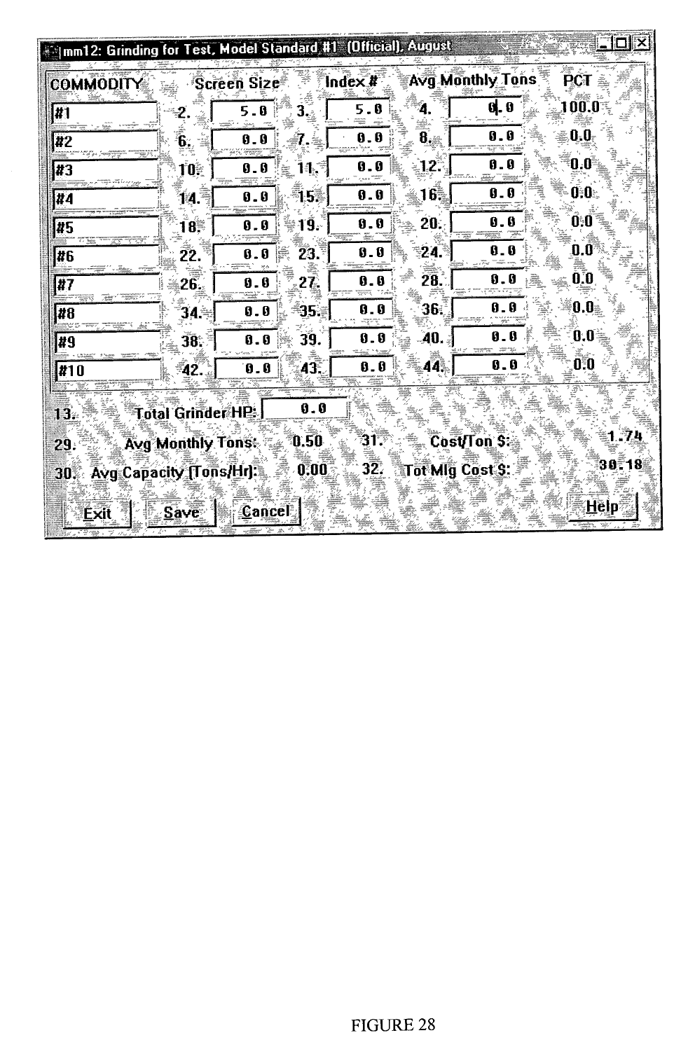

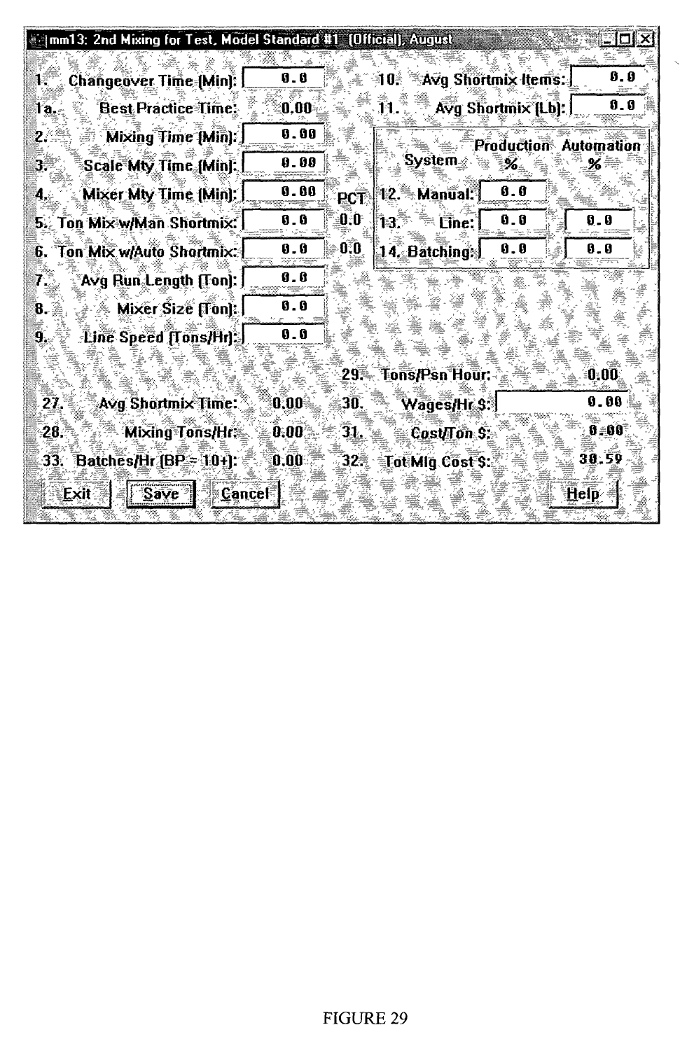

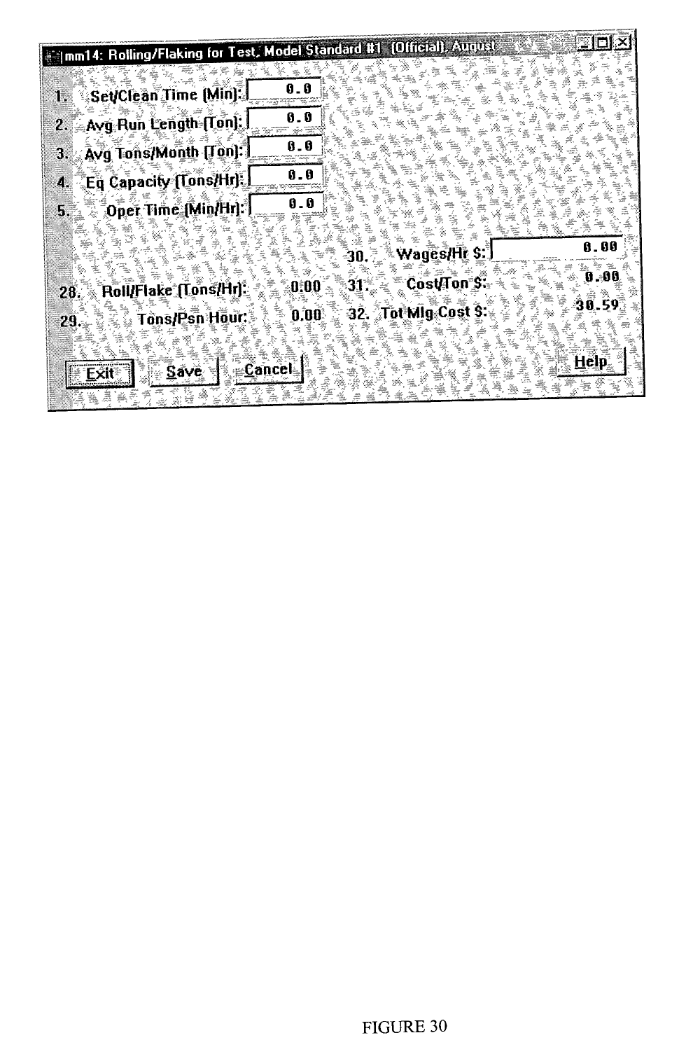

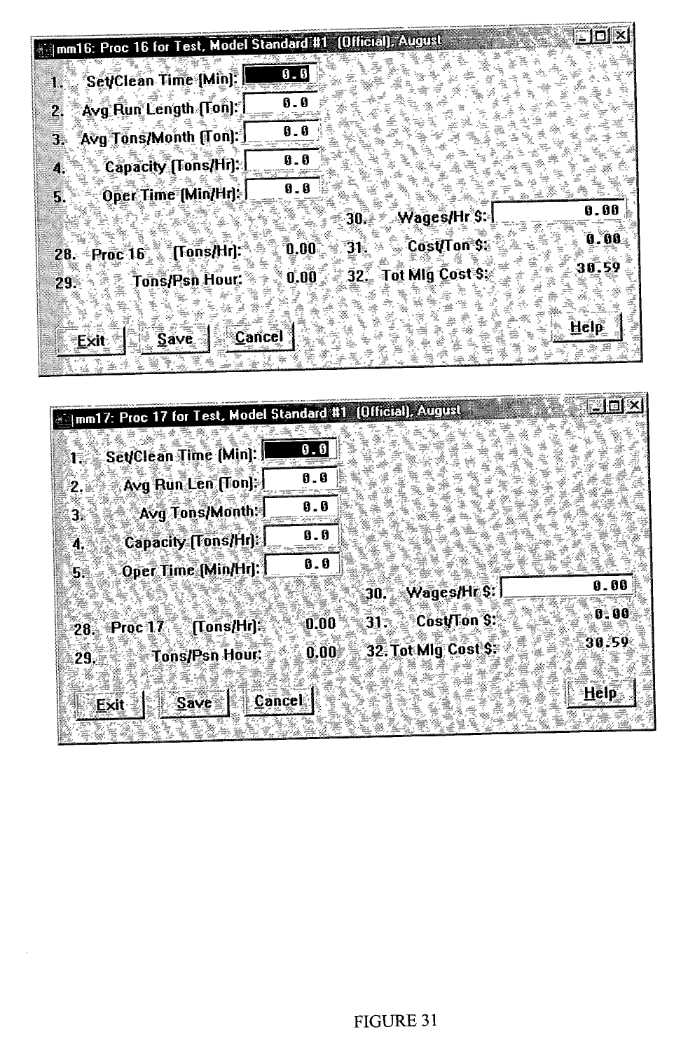

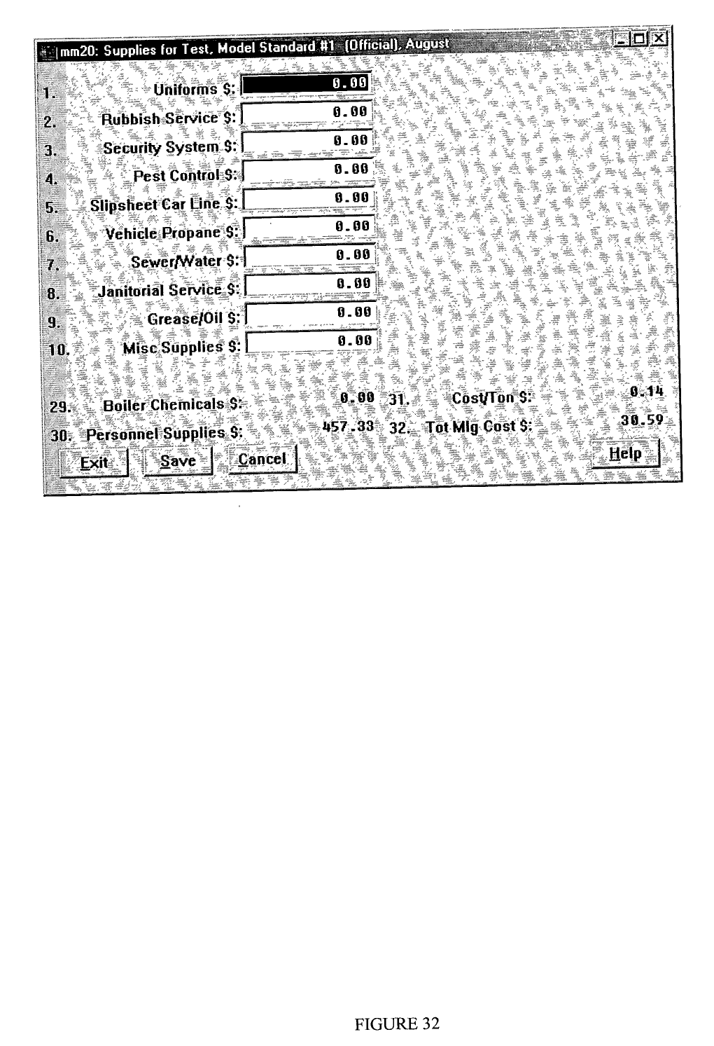

According to various alternative embodiments, other processes or data may be provided, including user defined processes, grinding processes, second mixing processes, rolling processes, flaking processes, etc. (e.g., see FIGS. 28 to 32).

7. Actual Data

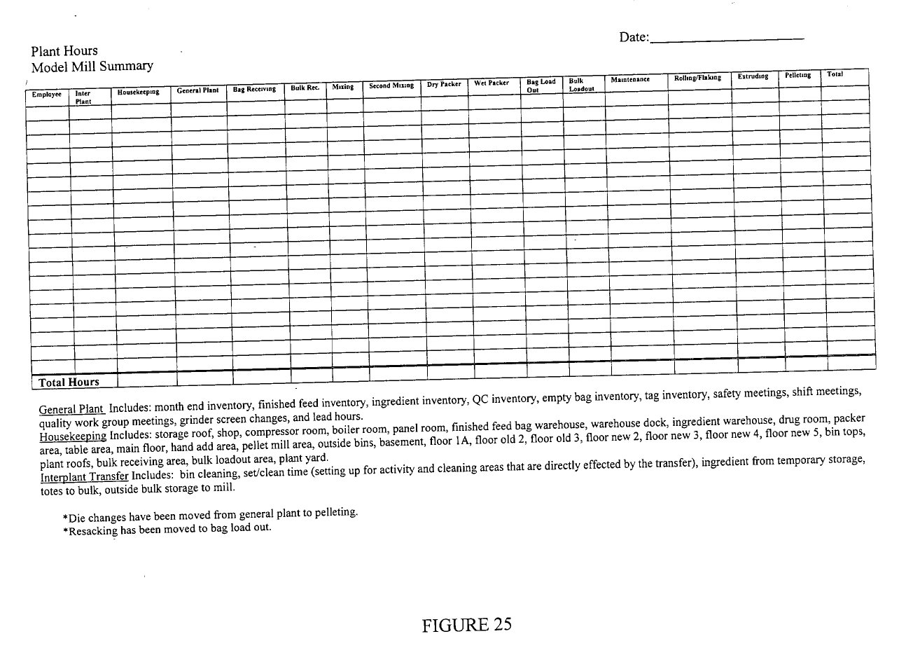

According to one exemplary embodiment, the actual data for the processes may be recorded manually throughout the process. For example, a worker conducting a housekeeping process or portion of a process (e.g., sweeping an area) may provide a start time for sweeping an area, and an end time for sweeping the area. Alternatively, the worker may provide an elapsed time. According to one exemplary embodiment, actual data may be recorded manually (e.g., on paper records, spreadsheets, etc.) and then later entered into system 10. Shown in FIG. 25 is a particularly preferred embodiment of a form which may be provided to employees in order to record and/or track times, costs, etc. with the various processes.

In a particularly preferred embodiment, actual data is entered after each production day. In an alternative embodiment, actual data may be entered directly into the system by the worker at a variety of locations such as terminals in communication with the system. In another alternative embodiment, the system may be coupled to equipment in the production facility via direct connections, wireless connections, and/or a communications network. The equipment may supply actual data about the process from the machines to the system, so that no (or less) manual entry of data would have to occur.

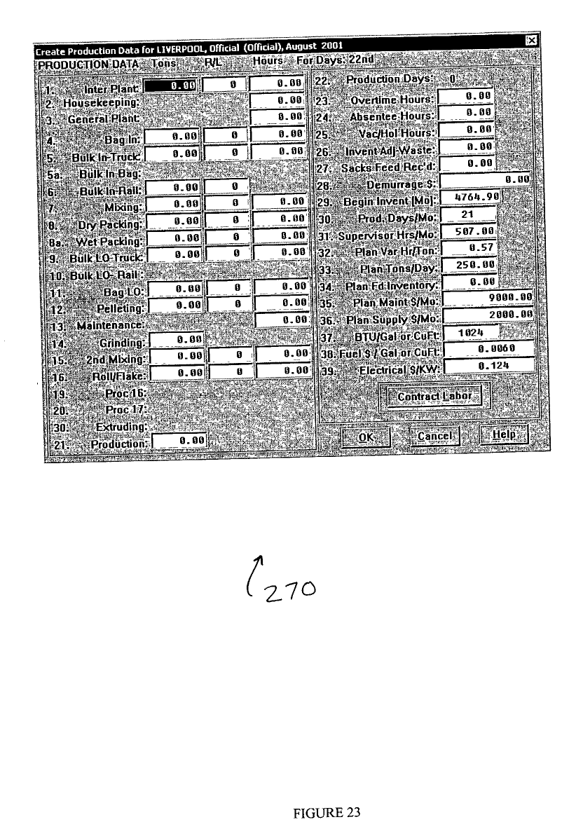

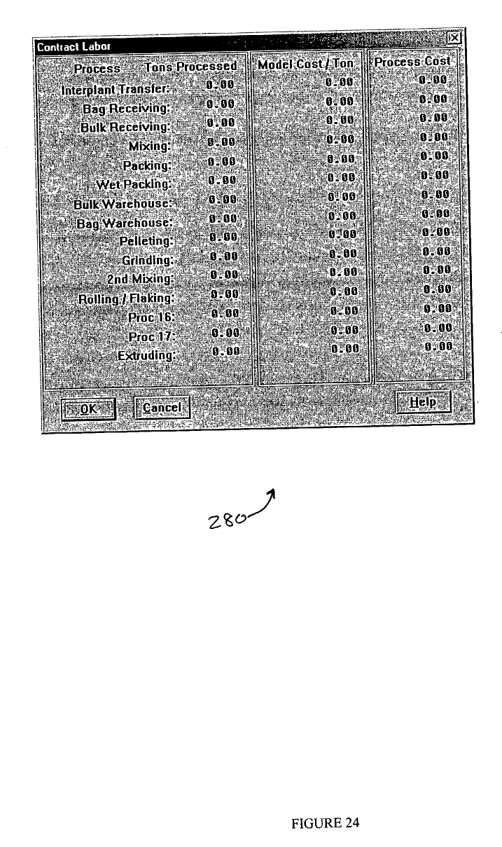

According to a particularly preferred embodiment shown in FIGS. 23 and 24, actual data may be entered or provided in a “Production Data” screen 270. Actual data relevant to various processes may be provided via an interface having actual process data fields. For example, FIELD 1 in FIG. 1 allows for entry of the actual tons of product that have been processed in the interplant process. Furthermore, FIELD 1 allows for entry of a run length for the interplant process. Furthermore, FIELD 1 allows for entry of time associated with the interplant process. Additional fields for actual data are provided for various process and data fields (see FIG. 23). As shown, actual data is entered at a process level (e.g., time, tons and run-length). Alternatively, actual data may be provided for each step or sub-process of the process (e.g., mirroring the model data fields provided for each process). Shown in FIG. 24 is a particularly preferred embodiment of an interface 280 which allows for the entry of data relating to contract labor processes, or processes which have utilized a contract vendor.

8. Analysis—Comparison of Model Data and Actual Data

According to various exemplary embodiments, various types, levels and quality of analysis may be conducted on the model data and the actual data.

Analysis may be done in order to optimize operational efficiency, production efficiency, costs, etc.

Shown in FIG. 3 is an exemplary process of analyzing model data 40 and/or actual data 50. Actual data 50 and model data 40 for various processes, facilities, etc. may be compared. Model data 40 may present a base line or metric to measure, analyze or assess actual data 50. According to the particularly preferred embodiment comparing actual data 50 and model data 40 comprises identifying and/or calculating a difference (e.g., subtraction, comparison, etc.) between actual data 50 and model data 40.

According to another particularly preferred embodiment an efficiency may be calculated based on actual data 50 and model data 40. For example, an efficiency may be actual data 50 divided by model data 40 or vice versa. Efficiencies be calculated on a cost per ton, amount of excess cost, time efficiency, etc.

According to a particularly preferred embodiment, the model data fields which allow for user entry are manipulated and calculated into model values that may be compared to the actual data fields. For example, in a housekeeping process, model housekeeping data may be generated from the data entry fields provided for comparison to the actual data. The model housekeeping data may be in a form that allows for direct comparison to the actual data. For example, one or more or all of the data entry fields may be used to create an overall model housekeeping value (e.g., a sum of the hours needed to complete all housekeeping processes or steps shown in FIG. 7). The overall model housekeeping value may then be directly compared with the actual data. Similar overall model values for the various processes may be generated for comparison to the actual data shown in FIG. 23 (e.g., hours, tons involved in process, run length, etc).

System 10 advantageously provides information regarding the operation and production of a facility which may be used to improve aspects of operation. For example, system 10 may provide reports summarizing various actual processes and how they compare to model processes. These reports may be provided at any level of detail (e.g., at a housekeeping process level, at a certain sweeping process level, etc. at a plant level, region level). The reports may be used to identify areas which may not be operating as expected, bottlenecks, problem areas, areas which need improvement, that are below a predetermined level or that are above a predetermined level. The reports assist in comparing model or ideal values to actual values in areas relating to productivity, maintenance, supplies, energy, labor, consumption, etc.

Efficiency may be reviewed daily, weekly, monthly, etc. Trends may be identified in various processes. For example, if efficiency trends downward, that process may be investigated to identify a problem. The problem may be equipment (e.g., improper design, not used to full capacity, etc.), personnel (e.g. too many people for a production run, process, etc.), procedures or process (e.g., late orders, wait on formulas, changes in schedule, flushing, etc.) or other factors.

Reports provide information to identify a problem or to localize an area of improvement, and also allows for corrective action to be taken. Alternatively, system 10 may be configured to respond based on the comparison of the actual data to the model data. Reports may also provide productivity measurement (i.e., a measurement of the labor and process efficiency of total plant and/or by process).

System 10 advantageously allows for “what-if” modeling of the facility, providing expected results or changes when altering the operating parameters without having to actually alter the operating parameters. For example, data can be changed “on-the-screen” and the results of those changes can be presented for consideration and/or implementation. For example, the average run length for mixing from first weight to a second weight and the results of this change (e.g. a cost savings, a cost increase, etc.) will be presented. Such results may then be useful for scheduling (i.e. if increasing the average run length results in a cost savings) more personnel, more runs of longer length, etc. may be scheduled.

Additionally, the incremental cost to produce additional product may be determined. For example, by increasing production of bulk pellets by 1000 tons, only variable costs may change. The reports (e.g., MM1, MM2, MM3 reports) provide data which illustrates the differences between before and after changes.

Additionally, cost effects of various labor and wages cost may be varied to illustrate the financial impact over a period of time, and showing the overall cost of product produced. For example, consideration may be given to buying new equipment (e.g. a new packer machine). A scale rate may be 10 bags/min.; a new packer machine may have a scale rate of 20 bags/min. The machine may cost $50,000. Scale rates may be adjusted and the report shows that the effect as being a lower cost per ton. Based on output, a return-on-investment may then be calculated.

System 10 also advantageously allows for budgeting and cost allocation. For example, historical data may be analyzed to predict future expenditures. System 10 may also allow for cost monitoring, including cost monitoring to be done at relatively high intervals, including daily and/or monthly. Cost monitoring may be conducted at the facility level, process level, sub-process level, etc.

System 10 also advantageously provides for capacity determination to assist with present and future planning, utility needs and individual process capacities. Appropriate staffing or crewing may also be determined using system 10. A project may be properly staffed based on various production amounts, product mix changes, etc.

For example, an estimate of tons of product will be produced in the next month may be provided. (The estimate may be from a budget for the present year and adjusted for other factors, such as marketing, manager predictions, etc. The estimated tons of product for each operation at the plant may be adjusted. Estimating production for each operation may then be done. For example, if pelleting comprises 50% our production, and assuming the estimated tons of product for the next month is known, the amount of pelleting tons will be estimated. The number of hours to produce may then be calculated (e.g. estimated tons divided by adjusted tons/man-hour). Using the hours required, the number of employees needed for a production may be calculated (e.g., employees required=Total hours/8 hr per worker per day/work days to complete operation).

9. Reporting

According to an exemplary embodiment, system 10 may generate one or more reports containing analysis, summaries, data, etc. which may be used in reviewing facility 18.

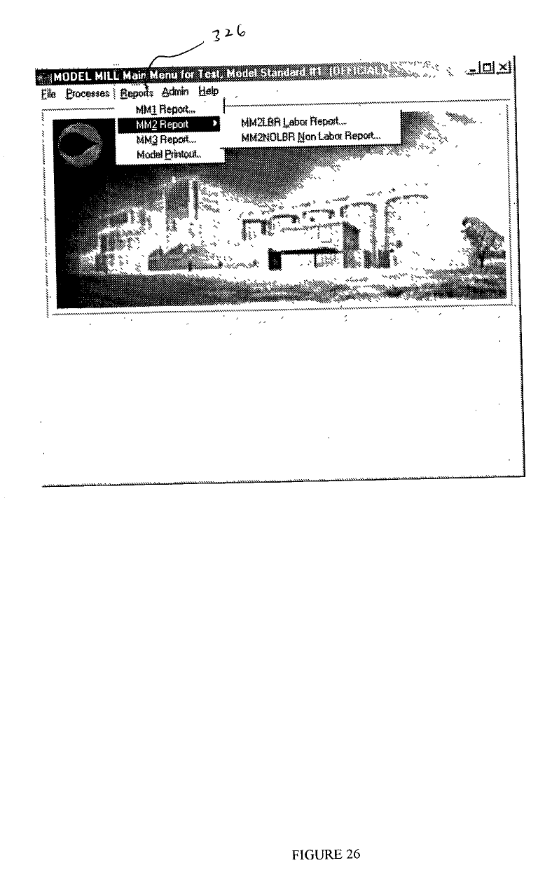

As shown in FIG. 26, a reporting feature may be accessed through a menu item 326 and/or by other operations and/or commands.

In a particularly preferred embodiment, a variety of reports may be provided which contain summary statistics for actual mill, production mix and labor hours, various types of product as a percent of sales (e.g., bulk sales as a percent of total sales, etc.). Further, reports summarizing costs per day for a particular facility may be generated. A report summarizing model facts and parameters may also be generated.

In an exemplary embodiment, any of a variety of reports may be generated, including but not limited to production summary reports, model summary reports, estimated actual plant expenses and estimated model expenses. An exemplary production summary report may provide information relating to actual production statistics. The production statistics may be presented on a daily basis or on a monthly (cumulative) basis or alternatively may be provided on other desired intervals. The model summary report may include information, assumptions, and/or parameters relating to the model and on which the model is based. Further, the model summary report may alternatively include a report on different models, and/or include details of multiple models. The estimate of actual and model plant expenses report may be used to detail estimated actual expenses based on data that is input from the production process during a given period of time (e.g., one day, 30 days, etc.) as well as estimated adjusted model expenses which are representative of the expenses for the operation of the model production facility. Further still, a history report may be accessed to provide historical data and trends for the facility. In an exemplary embodiment, such information may be communicated by tables, charts, graphs, numerical listings, etc.

Other reports which may be accessed in the systems described above include but are not limited to reports providing information from different plants at different locations. Such reports provide simplified comparison of the performance of various plants at different locales. Also, a year-to-date report may be accessed and/or generated at anytime providing up to date information of the facility and up to date comparisons of the facility with the model from a year-to-date perspective. Reports such as this include a world class standing report, which may include information relating to management criteria and goals compared with actual facility numbers. A plant operations report may also be provided for detailing plant and model comparison in various geographic categories. Further still, reports for any particular facility and/or for all facilities may be generated, including but not limited to monthly productivity summaries, year-to-date productivity summaries, cost structure summaries, and the like.

Reports representative of some of the above are provided in Appendices A to O. The appendices provided are representative of those possible and/or available and should not be seen as limiting. The reports provided include a null data set, as information in the reports is dependent entirely on the facility and therefore would not serve to provide instructive information relating to the systems and methods described.

In an exemplary embodiment, the reports may be accessed and/or generated from a server that is coupled to a communications network. Such functionality allows management at any location to access reports needed to make managing decisions about the facilities. Also, such a reporting system allows management at a centralized location to access reports relating to facilities that may be located worldwide. Reports may also be generated which include data from various divisions even if the division of interest has multiple production facilities.

10. Consulting Services

According to one exemplary embodiment shown in FIG. 1, system 10 comprises a server 12 containing a database 15 which may store model data, actual data, programs, etc. One or more facilities may access database 15. According to a particularly preferred embodiment, the one or more facilities may be related (e.g., operate under the management and control of a single entity such as a corporation, subsidiaries, parent companies, etc.).

According to an alternative embodiment, system 10 may be used to provide consulting services to facilities not associated or affiliated with itself.

For example, companies which desire to improve operations, production, cost, and other parameters may use, hire, retain or otherwise utilize consulting services. According to a particularly preferred embodiment, actual data may be provided to the consultant and then analyzed by the systems and methods described. Alternatively, the consultant may install a system for use by the unrelated company.

As shown in FIG. 1, system 10 may comprise a server 12 containing a first database 15 and a second database 25. First database 15 may be used for model data, actual data, program data, etc. of facilities operating within the company. Second database 25 may be used for model data, actual data, program data, etc. of facilities outside independent of the company (e.g., companies which have hired or retained the company for consulting services.).

This configuration advantageously separates the consulting data and the company data, providing an additional level of security, etc. However, other configurations may be used to similarly provide consulting services using the system described.

11. Alternative Embodiments

In an alternative embodiment, the systems and methods may be used to streamline and/or enhance the budgeting process. For example, in conventional systems, future cost projections may not be automated but are based on historical information contained in the system database. However, providing suitable software code that provides access to the system database and uses information that would typically appear on multiple screens, would enable the information to be automatically accessed and an algorithm applied to make budget projections including extrapolated information and projections, such as for energy costs and the like.

In another alternative embodiment, the systems and methods may include screens including alternative equipment (e.g. robotic stackers, fat coaters, etc.) and/or may be reformatted for data relating to other equipment, including but not limited to robotic equipment like stackers, stacking bags, etc.

In yet another alternative embodiment, the system may be coupled to the equipment in the production facility via direct connections and/or a communications network. The equipment would supply data about the production process directly from the machines to the system, so that no (or less) manual entry of data would have to occur. In yet still another alternative embodiment, a system that is in communication with the equipment, may also include an expert system, or other type of controls and/or intelligence to make decisions that are based on comparisons made using the system and are then fed back to the plant itself to make adjustments to machine and/or human parameters. Further, data collection may occur in real-time and it may then be possible to view plant efficiencies in real-time or near real-time. Data links may also be provided to logistics systems such as real time logistics systems, ingredient inventory and shipment systems, etc. for receiving, shipping, and production data inputs. Also, the database accessed by the system may include a database of equipment capacities and may be used to analyze equipment utilization.

In yet still other alternative embodiments, the system may be adapted to display graphs and charts of certain and/or specified parameters. Further still, the system may be configured to adapt to other industries so that it may be used for consulting and/or in different production contexts including, but not limited to food production facilities. Such adaptations include providing new fields and the renaming of certain fields within the program as well as providing customized reports for the particular facility. Yet further still, an alternative embodiment may include product quality factor information as well as information relating to other specialized processes.

And yet still further, alternative embodiments may apply to numerous enhancements which utilize a variety of defined inputs and/or input screens, such as but not limited to ingredient and/or feed processing screens, sanitized feed processing inputs, rationing system information used at the bulk load out area, micro auto batching system information (e.g., direct link information from the processing facility), post grind system after batching information (e.g., information gathered after the feed has been mixed and ground), aqua processing information (e.g., information relating to processes involving the introduction of liquids), as well as other information.

In yet still further alternative embodiments, the systems and methods may be used to compare information relating to the quality of the product when compared with an idealized or target quality. Further, the systems and methods may be applied to applications in other industries, including but not limited to the food processing industry and flour milling operations. Additionally, connection to electricity or other energy software which estimates cost and usage may be used to determine usage patterns and control savings. It may also be beneficial to provide reports that may be separated for different divisions and geographic locations. Further, alternative embodiments may include functionality which allows a variety of types of structured reporting that may be simply customized by a user without program modification.

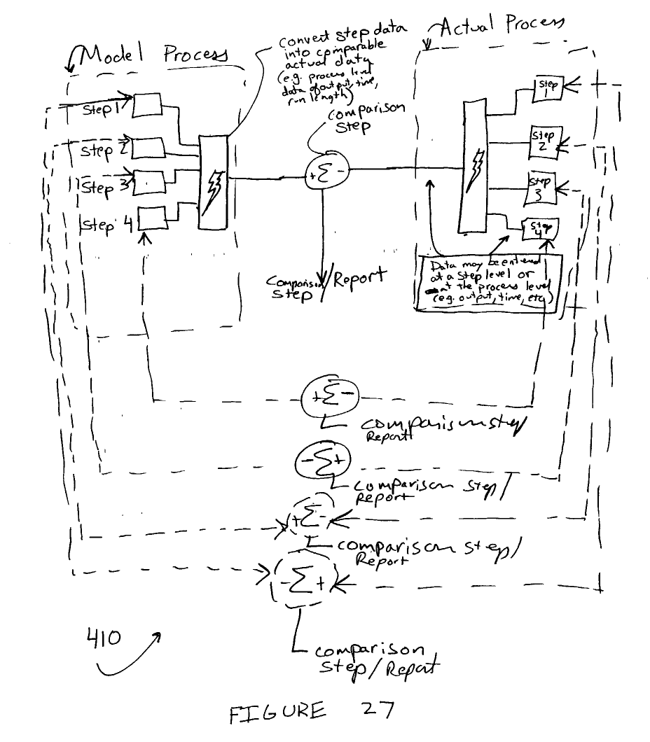

And yet still further, another alternative embodiment is shown in FIG. 27. Facilities management system 410 may analyze or assess data at a process level (e.g., multiple steps of a process are converted into data that can be compared to typical, measured production data (e.g., tons, time, run-length, etc. of the process as a whole). Alternatively, model data for the various steps of the process (e.g., data fields shown in FIGS. 6 to 22) may be compared to actual data for the various steps of the process (e.g., the actual steps of the process may be measured and compared to the model data).

While the embodiments illustrated in the figures and described above are presently preferred, it should be understood that these embodiments are offered by way of example only. While exemplary embodiments describe the invention in the context of facilities management, the invention may extend to other areas of production. The invention is not limited to a particular embodiment, but extends to various modifications, combinations, and permutations that nevertheless fall within the scope and spirit of the appended claims.

What is claimed is:

1. A system for modeling a production plant, the system comprising:
a processing unit; and
a memory portion in communication with the processing unit having information stored therein to configure the processing unit to:
receive model data for the production plant;
receive operational data for the production plant;
compare the operational plant data to the model plant data; and
generate a report at least daily containing the comparison between the operational plant data and the model plant data.

2. A method of managing a transfer of material within a plant, the method comprising:
receiving model bin storage data;
receiving model flat storage data;
generating model data from the model bin storage data and the model flat storage data;
receiving actual transfer data; and
comparing the model data with the actual transfer data.

3. The method of claim 2, wherein the model bin storage data further comprises data relating to at least one of time for bin cleaning, rate for bin cleaning, leg capacity, ingredient density, operator time, set time, clean time, average run length, and tons per month.

4. The method of claim 2, wherein the model flat storage data further comprises data relating to at least one of leg capacity, practical leg capacity, ingredient density, operator time, set time, clean time, average run length, and tons per month.

5. The method of claim 2, wherein actual transfer data comprises data relating to at least one of tons associated with the transfer of material, run length associated with the transfer of material, and hours associated with the transfer of material.

6. A method of managing physical maintenance of a plant, the method comprising:
receiving model maintenance data;
generating model data from the model maintenance data;
receiving actual maintenance data; and
comparing the model data with the actual maintenance data;
wherein the model maintenance data further comprises data relating to at least one of a mezzannine area, and a sweeping time based on empirical data.

7. The method of claim 6, wherein actual maintenance data comprises data relating to hours associated with the physical maintenance of the plant.

8. A method of managing personnel time for a recurring meeting in a plant, the method comprising:
receiving model data relating to a number of employees for the recurring meeting;
receiving model data relating to a time per employee for the recurring meeting;
generating model data relating to a total number of hours required for the recurring meeting;
receiving actual data relating to a total number of hours for the recurring meeting; and
comparing the model data relating to the total number of hours required for the recurring meeting with the actual data relating to the total number of hours for the recurring meeting.

9. The method of claim 8 wherein the recurring meeting is a safety meeting.

10. The method of claim 8 wherein the recurring meeting is a shift meeting.

11. A method of managing a bag material receiving process in a plant, the method comprising:
receiving model bag receiving data;
generating model data from the model bag receiving data;
receiving actual bag receiving data; and
comparing the model data with the actual bag receiving data;
wherein the model bag receiving data further comprises data relating to at least one of amount of bag material received with a forklift, and a capacity of the forklift.

12. The method of claim 11, wherein actual bag receiving data comprises data relating to at least one of tons associated with the bag material receiving process, run length associated with the bag material receiving process, and hours associated with the bag material receiving process.

13. A method of managing a bulk material receiving process in a plant, the method comprising:
receiving model dumping data;
generating model data from the model dumping data;
receiving actual dumping data; and
comparing the model data with the actual dumping data.

14. The method of claim 13 wherein the model dumping data and the actual dumping data further comprises data relating to at least one of bag size, bag tons per month, bags dumped per time, bags dumped per hour, operator time, set time, clean time, weigh time, sample time, testing time, average load size, and dump tons per person hour.

15. A method of managing a mixing process in a plant, the method comprising:
receiving model mixing data;
generating model data from the model mixing data;
receiving actual mixing data; and
comparing the model data with the actual mixing data;
wherein the model mixing data further comprises data relating to at least one of a best practice time for mixing, and a batches per hour.

16. The method of claim 15, wherein actual mixing data comprises data relating to at least one of tons associated with the mixing process, run length associated with the mixing process, and hours associated with the mixing process.

17. A method of managing a packing process in a plant, the method comprising:
receiving model dry packing data;
receiving actual dry packing data;
comparing the model dry packing data with the actual dry packing data;
receiving model wet packing data;
receiving actual wet packing data; and
comparing the model wet packing data with the actual wet packing data.

18. The method of claim 17, wherein actual dry packing data and actual wet packing data comprises data relating to at least one of tons associated with the packing process, run length associated with the packing process, and hours associated with the packing process.

19. The method of claim 17, wherein comparing the model dry packing data with the actual dry packing data further comprises calculating a dry packing efficiency.

20. The method of claim 17, wherein comparing the model wet packing data with the actual wet packing data further comprises calculating a wet packing efficiency.

21. The method of claim 17, wherein at least one of the model dry packing data, the actual dry packing data, the model wet packing data, the actual wet packing data further comprises bag size data.

22. The method of claim 21, wherein the bag size data further comprises data relating to at least two bag sizes.

23. The method of claim 22, wherein the bag size data further comprises data relating to at least one of average bag weight, scale rate of number of bags per time, scale rate of number of bags per minute, actual rate of bags per time, actual rate of bags per minute, and bag tons per month.

24. The method of claim 17, wherein at least one of the model dry packing data and the model wet packing data comprises data relating to a manufacturer specification for at least one piece of packing equipment.

25. The method of claim 24, wherein the at least one piece of packing equipment is a piece of automated packing equipment.

26. The method of claim 17 wherein at least one of the model wet packing data and the actual wet packing data further comprises data relating to liquid addition, setup and clean up time.

27. A method of managing a shipping process in a plant, the method comprising:
receiving model shipping data;
generating model data from the model shipping data;
receiving actual shipping data; and
comparing the model data with the actual shipping data;
wherein the model shipping data further comprises data relating to one of a set time for a rail car, a clean time for a rail car, a sample time for a rail car, a weigh time for a rail car, an operator rate for a rail car, a load rate for a rail car, a wet clean rate, a wet load rate, a wet average tons per item, and a resacking rate.

28. The method of claim 27, wherein actual shipping data comprises data relating to at least one of tons associated with the shipping process, run length associated with the shipping process, and hours associated with the shipping process.

29. A method of managing a pelleting process in a plant, the method comprising:
receiving model pelleting data;
generating model data from the model pelleting data;
receiving actual pelleting data; and
comparing the model data with the actual pelleting data;
wherein the model pelleting data further comprises data relating to one of die friction, throughput of a pelleting machine, energy cost of the pelleting machine, and a time required to change a die of a pelleting machine.

30. The method of claim 29, wherein actual pelleting data comprises data relating to at least one of tons associated with the pelleting process, run length associated with the pelleting process, and hours associated with the pelleting process.

31. A method of managing a maintenance process in a plant, the method comprising:
receiving model maintenance data;
generating model data from the model maintenance data;
receiving actual maintenance data; and
comparing the model data with the actual maintenance data;
wherein the model maintenance data further comprises data relating to one of a number of extruders, and a number of dryers.

32. The method of claim 31, wherein actual maintenance data comprises data relating to hours associated with the maintenance process.

33. A method of managing an energy consumption process in a plant, the method comprising:
receiving model energy consumption data;
generating model data from the model energy consumption data;
receiving actual energy consumption data; and
comparing the model data with the actual energy consumption data;
wherein the model energy consumption data further comprises data relating to one of an energy amount associated with an extruding process, an energy amount associated with an extrusion screen, an additional amount of steam, an additional BTU usage, and wet packing amps.

34. The method of claim 33, wherein actual energy consumption data comprises data relating to at least one of fuel cost, BTU per volume of product, and cost per kilowatt.

35. A method of managing operations processes in a plant, the method comprising:
receiving model operations processes data;
generating model data from the model operations processes data;
receiving actual operations processes data; and
comparing the model data with the actual operations processes data;
wherein the model operations processes data further comprises data relating to one of a cost associated with a security guard and a currency conversion.

36. The method of claim 35, wherein actual operations processes data comprises data relating to at least one of overtime data, absentee data, vacation data, demurrage, and supervisor hours.

37. A method of managing contract labor in a plant, the method comprising:
receiving model contract labor data;
receiving actual contract labor data; and
comparing the model contract labor data with the actual contract labor data;
wherein the model contract labor data and the actual contract labor data further comprise data relating to a cost associated with contracting one of interplant transfer, bag receiving, bulk receiving, mixing, packing, wet packing, bulk warehouse, bag warehouse, pelleting, grinding, second mixing, rolling, flaking, grain processing, block pressing, and extruding.

38. A method of managing an extruding process in a plant, the method comprising:
receiving model extruding data;
generating model data from the model extruding data;
receiving actual extruding data; and
comparing the model data with the actual extruding data;
wherein the model extruding data further comprise data relating to a cost associated with one of an energy cost associated with the extruding process and a labor cost associated with the extruding process.

39. The method of claim 38, wherein actual extruding data comprises data relating to at least one of tons associated with the extruding process, run length associated with the extruding process, and hours associated with the extruding process.

40. A method of managing a facility having at least one process, the at least one process having a plurality of steps, the method comprising:
receiving model data relating to the plurality of steps of the at least one process;
receiving actual data relating to the plurality of steps of the at least one process; and
comparing the model data to the actual data.

41. The method of claim 40 wherein the at least one process is at least one of interplant transfer, bag receiving, bulk receiving, mixing, packing, wet packing, bulk warehouse, bag warehouse, pelleting, grinding, second mixing, rolling, flaking, grain processing, block pressing, and extruding.

42. The method of claim 40 wherein comparing the model data to the actual data comprises at least one of providing a difference between the model data and the actual data, calculating and efficiency of the actual data compared to the model data.

43. The method of claim 42 wherein the plurality of steps of the at least one process comprise steps associated with at least one of interplant transfer, bag receiving, bulk receiving, mixing, packing, wet packing, bulk warehouse, bag warehouse, pelleting, grinding, second mixing, rolling, flaking, grain processing, block pressing, and extruding.

44. A method of providing consulting services, comprising:
receiving, by a consulting servicer, operational data from a production plant;
generating model data for the production plant;
generating comparison data from the operational data and the model data, by the consulting servicer;
generating, by the consulting servicer, a report analyzing the operational data, the model data and the comparison data.

45. A method of providing management reports for a production plant, comprising:
receiving operational data at least partially automatically from machines in the production plant, by a data processing device;
generating model data for the production plant using a production plant modeling program running on the data processing device; and
generating a report based on the operational data and the model data.
